(19) United States
(12) Patent Application Publication
(10) Pub. No.: US 2025/0286765 A1
(43) Pub. Date: Sep. 11, 2025

(54) DFT-s-OFDM SIGNAL WITH SPECTRUM EXTENSION

(71) Applicant: HUAWEI TECHNOLOGIES CO., LTD., Shenzhen (CN)

(72) Inventors: Renaud-Alexandre Pitaval, Kista (SE); Fredrik Berggren, Kista (SE); Branislav M. Popovic, Kista (SE)

(73) Assignee: HUAWEI TECHNOLOGIES CO., LTD., Shenzhen (CN)

(21) Appl. No.: 19/054,653

(22) Filed: Feb. 14, 2025

Related U.S. Application Data
(63) Continuation of application No. PCT/EP2022/072944, filed on Aug. 17, 2022.

(51) Int. Cl. H04L 27/26

(52) U.S. Cl. CPC H04L 27/2636; H04L 27/2613

(57) ABSTRACT

Embodiments of the invention relate to DFT-s-OFDM signal with spectral extension. A communication device is provided that obtains N_{data} Fourier coefficients based on N_{data} data symbols, and repeats Nₑ Fourier coefficients of the N_{data} Fourier coefficients to obtain N_{sc} Fourier coefficients, wherein Nₑ is determined based on at least one of a modulation symbol constellation of the N_{data} data symbols, and a frequency domain spectrum shaping (FDSS) window of the communication device. The N_{sc} Fourier coefficients are multiplied with an FDSS window of size N_{sc} to obtain N_{sc} frequency shaped Fourier coefficients which are mapped onto N_{sc} subcarriers to obtain a discrete Fourier transform spread orthogonal frequency division multiplexing (DFT-s-OFDM) signal, which is transmitted.

### CROSS-REFERENCE TO RELATED APPLICATIONS

This application is a continuation of International Application No. PCT/EP2022/072944, filed on Aug. 17, 2022, the disclosure of which is hereby incorporated by reference in its entirety.

### TECHNICAL FIELD

Embodiments of present disclosure relate to a first communication device and a second communication device for a discrete Fourier transform spread orthogonal frequency division multiplexing (DFT-s-OFDM) signal with spectral extension. Furthermore, embodiments of the present disclosure also relate to corresponding methods and a computer program.

### BACKGROUND

Uplink transmissions are considered to be the coverage bottleneck of modern wireless systems due to limited user equipment (UE) transmission power. Therefore, uplink coverage enhancement is an important topic in current 3GPP new radio (NR) standardization. For coverage-limited scenario, the envelope fluctuation of the transmitted signals, typically measured by its cubic metric (CM) or peak-to-average power ratio (PAPR), should be as small as possible. This because a signal with higher CM/PAPR requires the power-amplifier to operate with larger power back-off in order to avoid signal distortion from its non-linear amplification range, directly impacting the link budget of the transmission.

Orthogonal frequency division multiplexing (OFDM) is to date the dominant modulating waveform of wireless communications systems, and the basis waveform of 3GPP standards in both the uplink and downlink. Discrete Fourier transform spread OFDM (DFT-s-OFDM) is a variant of OFDM principally used to achieve lower PAPR transmission than with standard OFDM. In DFT-s-OFDM the data symbols are first DFT-precoded before OFDM modulation, which leads to a form of single-carrier waveform as then the modulation symbols have their energy spread over all subcarrier in the allocated frequency spectrum. Reciprocally, in the time-domain, a large portion of a symbol energy is concentrated in short interval resulting in a time-domain multiplexing of symbols.

While PAPR is improved with DFT-s-OFDM, it can still be unsatisfactory, e.g., in deep-indoor coverage-limited scenario. Thus, additional low-PAPR techniques have been considered in 3GPP for uplink transmission. For example, 5G NR supports π/2-BPSK in uplink in addition to legacy LTE constellations, aiming at providing further PAPR reduction and thus boosting radio frequency (RF) amplifier power efficiency at lower data-rates. In current 5G NR, π/2-BPSK can also be used with frequency domain spectrum shaping (FDSS). FDSS enables also to bring additional PAPR reduction at the cost of manageable self-interference. No specific FDSS window is in fact defined in NR specification but is only indirectly permitted through looser RAN4 spectral flatness requirements specific for NR uplink with π/2-BPSK.

Spectrum extension (SE) with FDSS is another PAPR reduction technique currently not specified in NR but listed as a potential solution. The main goal would be to achieve lower-PAPR also for high-order modulation such as QPSK and thus improving also the coverage for higher data rates.

### SUMMARY

The present disclosure provides a solution that mitigates or solves drawbacks and problems of conventional solutions.

The present disclosure provides a solution reducing PAPR compared to conventional solutions.

According to a first aspect, a first communication device for a communication system is provided, the first communication device being configured to
obtain a N_{data} number of Fourier coefficients based on a N_{data} number of data symbols, wherein N_{data} is a positive integer;
repeat a Nₑ number of Fourier coefficients of the N_{data} number of Fourier coefficients to obtain a N_{sc} number of Fourier coefficients, wherein Nₑ and N_{sc} are positive integers and wherein Nₑ is determined based on at least one of: a modulation symbol constellation of the N_{data} number of data symbols, and a frequency domain spectrum shaping, FDSS, window of the first communication device;
multiply the N_{sc} number of Fourier coefficients with a FDSS window of size N_{sc} to obtain N_{sc} number of frequency shaped Fourier coefficients;
map the N_{sc} number of frequency shaped Fourier coefficients on a N_{sc} number of subcarriers to obtain a discrete Fourier transform spread orthogonal frequency division multiplexing, DFT-s-OFDM, signal; and transmit the DFT-s-OFDM signal.

An advantage of the first communication device according to the first aspect is that the first communication device allows the reduction of the PAPR of the DFT-s-OFDM signal. This is because the optimum reduction of PAPR and the value of Nₑ to achieve it depends greatly on the modulation symbol constellation used for data symbols and the FDSS window. Thus, the first communication device as a transmitter device can use a lower power backoff, and thereby increase the coverage of the DFT-s-OFDM signal.

In an implementation form of a first communication device according to the first aspect, Nₑ is determined further based on N_{sc} or N_{data}.

An advantage with this implementation form is further reduction of the PAPR of the DFT-s-OFDM signal according to the bandwidth allocation. This is because the value of Nₑ to achieve the optimum reduction of PAPR roughly proportionally increase with the bandwidth allocation, but with slight variation.

In an implementation form of a first communication device according to the first aspect, the modulation symbol constellation of the N_{data} number of data symbols is a π/2-BPSK constellation or a QAM constellation.

An advantage with this implementation form is that such constellations are used in 3GPP standards of which π/2-BPSK is specifically used to achieve a very low PAPR transmission which can be further improved by very different Nₑ values that with QAM constellation.

In an implementation form of a first communication device according to the first aspect,
Nₑ is predetermined; or
the first communication device is configured to receive a first control signal indicating Nₑ.

An advantage with this implementation form is that having Nₑ predetermined allows an easy implementation minimizing signaling overhead; or if Nₑ is indicated by signaling it allows better reduction of PAPR according to other transmission parameters or device-specific characteristics.

In an implementation form of a first communication device according to the first aspect, the Nₑ number of Fourier coefficient repetitions are:
included in allocated resources for the transmission of the DFT-s-OFDM signal; or
added to the allocated resources for the transmission of the DFT-s-OFDM signal.

An advantage with this implementation form is that with adjacent multiple user bandwidths, if including the repeated Fourier coefficients in the allocated resource of each user, avoids interference and the repeated symbols can then be used for improving demodulation performance; or if adding the repeated Fourier coefficients to the allocated resource the spectral efficiency is improved.

In an implementation form of a first communication device according to the first aspect, the first communication device being configured to transmit a second control signal indicating the capability of the first communication device of repeating the Nₑ number of Fourier coefficients.

An advantage with this implementation form is that Nₑ indicated by the first control signal can be determined based on the capability of the first communication device as indicated by second control signal. This allows optimized reduction of PAPR based on several configuration parameters and implementation aspects of the first communication device.

In an implementation form of a first communication device according to the first aspect, the first communication device being configured to, previous to multiplying the N_{sc} number of Fourier coefficients with the FDSS window:
cyclically shift the N_{sc} number of Fourier coefficients with a L number of Fourier coefficients to obtain N_{sc} number of cyclically shifted Fourier coefficients, wherein L is a positive integer;
multiply the N_{sc} number of cyclically shifted Fourier coefficients with the FDSS window of size N_{sc} to obtain N_{sc} number of frequency shaped and cyclically shifted Fourier coefficients; and
map the N_{sc} number of frequency shaped and cyclically shifted Fourier coefficients on the N_{sc} number of subcarriers to obtain the DFT-s-OFDM signal.

An advantage with this implementation form is that it allows further reduction of PAPR as the PAPR changes as a function of the cyclically shift coefficient L.

In an implementation form of a first communication device according to the first aspect,
L is predetermined; or
the first communication device is configured to receive a first control signal indicating L.

An advantage with this implementation form is that having L predetermined allows an easy implementation minimizing signaling overhead; or if L is indicated by signaling it allows better reduction of PAPR according to other transmission parameters or device-specific characteristics.

In an implementation form of a first communication device according to the first aspect, L is determined based on any of:
Nₑ, N_{data} or N_{sc};
the modulation symbol constellation of the N_{data} number of data symbols; and

$$L = round ( \frac{( 2 k + 1 )}{8} {N}_{data} - \frac{( {N}_{e} - 1 )}{2} ) , or$$

$$L = ⌈ \frac{( 2 k + 1 )}{8} {N}_{data} - \frac{( {N}_{e} - 1 )}{2} ⌉ , or$$

$$L = ⌊ \frac{( 2 k + 1 )}{8} {N}_{data} - \frac{( {N}_{e} - 1 )}{2} ⌋ or$$

$$L = round ( {N}_{data} - \frac{( {N}_{e} - 1 )}{2} ) , or$$

$$L = ⌈ {N}_{data} - \frac{( {N}_{e} - 1 )}{2} ⌉ , or$$

$$L = ⌊ {N}_{data} - \frac{( {N}_{e} - 1 )}{2} ⌋ ,$$

where k is a positive integer k, where round(x) gives the closest integer to x, and where ┌x┐ and └x┘ are the ceiling and floor operators on x, respectively.

An advantage with this implementation form is that it allows the best reduction of PAPR by selecting the best shifting function.

In an implementation form of a first communication device according to the first aspect, Nₑ≤Nₑ^{(opt)} is less than a maximum allowed Fourier coefficient repetition capability Nₑ^{(opt)} of the first communication device (100), and wherein Nₑ^{(opt)} is determined based on any of: the FDSS window, L, and N_{sc} and N_{data}.

An advantage with this implementation form is that it allows selecting a smaller Nₑ for improving spectral efficiency, and further avoids selecting a too large Nₑ that could increase PAPR.

In an implementation form of a first communication device according to the first aspect, the first communication device being configured to determine Nₑ≤Nₑ^{(opt)} to minimize a peak-to-average-power ratio, PAPR, of the transmission of the DFT-s-OFDM signal based on any of: the FDSS window, the modulation symbol constellation of the N_{data} number of data symbols, L, and N_{sc} or N_{data}.

An advantage with this implementation form is that it allows selecting Nₑ that optimize the PAPR performance according to transmission parameters or device-specific characteristics.

In an implementation form of a first communication device according to the first aspect, the first communication device being configured to transmit a second control signal indicating Nₑ^{(opt)}.

An advantage with this implementation form is that ensure that the selected Nₑ is not detrimental in term of PAPR according to the specific first communication device capability and implementation.

According to a second aspect, a second communication device for a communication system is provided, the second communication device being configured to:
receive a DFT-s-OFDM signal from a first communication device, the DFT-s-OFDM signal comprising a N_{sc} number of Fourier coefficients mapped on a N_{sc} number of subcarriers, wherein N_{sc} is a positive integer;
obtain the N_{sc} number of Fourier coefficients based on the DFT-s-OFDM signal, the N_{sc} number of Fourier coefficients comprising a N_{data} number of Fourier coefficients and a Nₑ number of repeated Fourier coefficients of the N_{data} number of Fourier coefficients, wherein N_{data} and Nₑ are positive integers, and the N_{data} number of Fourier coefficients are obtained based on a N_{data} number of data symbols, and wherein Nₑ is determined based on at least one of a modulation symbol constellation of the N_{data} number of data symbols, and a FDSS window of the first communication device;
obtain the N_{data} number of Fourier coefficients based on the N_{sc} number of Fourier coefficients; and
decode the N_{data} number of Fourier coefficients to obtain the N_{data} number of data symbols.

An advantage of the second communication device according to the second aspect is that the first communication device allows the reduction of the PAPR of the DFT-s-OFDM signal. This is because the optimum reduction of PAPR and the value of Nₑ to achieve it depends greatly on the modulation symbol constellation used for data symbols and the FDSS window. Thus, the first communication device as a transmitter device can use a lower power backoff, and thereby increase the coverage of the DFT-s-OFDM signal.

In an implementation form of a second communication device according to the second aspect, Nₑ is determined further based on N_{sc} or N_{data}.

An advantage with this implementation form is further reduction of the PAPR of the DFT-s-OFDM signal according to the bandwidth allocation. This is because the value of Nₑ to achieve the optimum reduction of PAPR roughly proportionally increase with the bandwidth allocation, but with slight variation.

In an implementation form of a second communication device according to the second aspect, the modulation symbol constellation of the N_{data} number of data symbols is a π/2-BPSK constellation or a QAM constellation.

An advantage with this implementation form is that such constellations are used in 3GPP standards of which π/2-BPSK is specifically used to achieve a very low PAPR transmission which can be further improved by very different Nₑ values that with QAM constellation.

In an implementation form of a second communication device according to the second aspect,
Nₑ is predetermined; or
the second communication device is configured to transmit a first control signal indicating Nₑ.

An advantage with this implementation form is that having Nₑ predetermined allows an easy implementation minimizing signaling overhead; or if Nₑ is indicated by signaling it allows better reduction of PAPR according to other transmission parameters or device-specific characteristics.

In an implementation form of a second communication device according to the second aspect, the Nₑ number of Fourier coefficient repetitions are:
included in allocated resources for the transmission of the DFT-s-OFDM signal; or
added to the allocated resources for the transmission of the DFT-s-OFDM signal.

An advantage with this implementation form is that with adjacent multiple user bandwidths, if including the repeated Fourier coefficients in the allocated resource of each user, avoids interference and the repeated symbols can then be used for improving demodulation performance; or if adding the repeated Fourier coefficients to the allocated resource the spectral efficiency is improved.

In an implementation form of a second communication device according to the second aspect,
the second communication device being configured to
   receive a second control signal indicating the capability of the first communication device of repeating the Nₑ number of Fourier coefficients.

An advantage with this implementation form is that Nₑ indicated by the first control signal can be determined based on the capability of the first communication device as indicated by second control signal. This allows optimized reduction of PAPR based on several configuration parameters and implementation aspects of the first communication device.

In an implementation form of a second communication device according to the second aspect, the second communication device being configured to, previous to obtain the N_{data} number of Fourier coefficients:
cyclically shift the N_{sc} number of Fourier coefficients with a L number of Fourier coefficients to obtain N_{sc} number of cyclically shifted Fourier coefficients, wherein L is a positive integer; and
obtain the N_{data} number of Fourier coefficients based on the N_{sc} number of cyclically shifted Fourier coefficients.

An advantage with this implementation form is that it allows further reduction of PAPR as the PAPR changes as a function of the cyclically shift coefficient L.

In an implementation form of a second communication device according to the second aspect,
L is predetermined; or
the second communication device is configured to transmit a second control signal indicating L.

An advantage with this implementation form is that having L predetermined allows an easy implementation minimizing signaling overhead; or if L is indicated by signaling it allows better reduction of PAPR according to other transmission parameters or device-specific characteristics.

In an implementation form of a second communication device according to the second aspect, L is determined based on any of:
Nₑ, N_{data} or N_{sc};
the modulation symbol constellation of the N_{data} number of data symbols; and
formulas

$$L = round ( \frac{( 2 k + 1 )}{8} {N}_{data} - \frac{( {N}_{e} - 1 )}{2} ) , or \\ L = ⌈ \frac{( 2 k + 1 )}{8} {N}_{data} - \frac{( {N}_{e} - 1 )}{2} ⌉ , or \\ L = ⌊ \frac{( 2 k + 1 )}{8} {N}_{data} - \frac{( {N}_{e} - 1 )}{2} ⌋ or \\ L = round ( {N}_{data} - \frac{( {N}_{e} - 1 )}{2} ) , or \\ L = ⌈ {N}_{data} - \frac{( {N}_{e} - 1 )}{2} ⌉ , or \\ L = ⌊ {N}_{data} - \frac{( {N}_{e} - 1 )}{2} ⌋ ,$$

where k is a positive integer k, where round(x) gives the closest integer to x, and where ┌x┐ and └x┘ are the ceiling and floor operators on x, respectively.

An advantage with this implementation form is that it allows the best reduction of PAPR by selecting the best shifting function.

In an implementation form of a second communication device according to the second aspect,
Nₑ≤Nₑ^{(opt)} is less than a maximum allowed Fourier coefficient repetition capability N opt) of the first communication device (100), and wherein Nₑ^{(opt)} is determined based on any of: the FDSS window, L, and N_{sc} and N_{data}.

An advantage with this implementation form is that it allows selecting a smaller Nₑ for improving spectral efficiency, and further avoids selecting a too large Nₑ that could increase PAPR.

In an implementation form of a second communication device according to the second aspect, Nₑ≤Nₑ^{(opt)} to minimize a PAPR of the transmission of the DFT-s-OFDM signal based on any of: the FDSS window, the modulation symbol constellation of the N_{data} number of data symbols, L, and N_{sc} or N_{data}.

An advantage with this implementation form is that it allows selecting Nₑ that optimize the PAPR performance according to transmission parameters or device-specific characteristics.

In an implementation form of a second communication device according to the second aspect, the second communication device being configured to
receive a second control signal indicating Nₑ^{(opt)}.

An advantage with this implementation form is that ensure that the selected Nₑ is not detrimental in term of PAPR according to the specific first communication device capability and implementation.

According to a third aspect, a method for a first communication device is provided, the method comprising:
obtaining a N_{data} number of Fourier coefficients based on a N_{data} number of data symbols, wherein N_{data} is a positive integer;
repeating a Nₑ number of Fourier coefficients of the N_{data} number of Fourier coefficients to obtain a N_{sc} number of Fourier coefficients, wherein Nₑ and N_{sc} are positive integers and wherein Nₑ is determined based on at least one of: a modulation symbol constellation of the N_{data} number of data symbols, and a FDSS window of the first communication device;
multiplying the N_{sc} number of Fourier coefficients with a FDSS window of size N_{sc} to obtain N_{sc} number of frequency shaped Fourier coefficients;
mapping the N_{sc} number of frequency shaped Fourier coefficients on a N_{sc} number of subcarriers to obtain a DFT-s-OFDM signal; and
transmitting the DFT-s-OFDM signal.

The method according to the third aspect can be extended into implementation forms corresponding to the implementation forms of the first communication device according to the first aspect. Hence, an implementation form of the method comprises the feature(s) of the corresponding implementation form of the first communication device.

The advantages of the methods according to the third aspect are the same as those for the corresponding implementation forms of the first communication device according to the first aspect.

According to a fourth aspect, a method for a second communication device is provided, the method comprising:
receiving a DFT-s-OFDM signal from a first communication device, the DFT-s-OFDM signal comprising a N_{sc} number of Fourier coefficients mapped on a N_{sc} number of subcarriers, wherein N_{sc} is a positive integer;
obtaining the N_{sc} number of Fourier coefficients based on the DFT-s-OFDM signal, the N_{sc} number of Fourier coefficients comprising a N_{data} number of Fourier coefficients and a Nₑ number of repeated Fourier coefficients of the N_{data} number of Fourier coefficients, wherein N_{data} and Nₑ are positive integers, and the N_{data} number of Fourier coefficients are obtained based on a N_{data} number of data symbols, and wherein Nₑ is determined based on at least one of a modulation symbol constellation of the N_{data} number of data symbols, and a FDSS window of the first communication device;
obtaining the N_{data} number of Fourier coefficients based on the N_{sc} number of Fourier coefficients; and
decoding the N_{data} number of Fourier coefficients to obtain the N_{data} number of data symbols.

The method according to the fourth aspect can be extended into implementation forms corresponding to the implementation forms of the second communication device according to the second aspect. Hence, an implementation form of the method comprises the feature(s) of the corresponding implementation form of the second communication device.

The advantages of the methods according to the fourth aspect are the same as those for the corresponding implementation forms of the second communication device according to the second aspect.

Embodiments of the invention also relate to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a first communication device according to embodiments of the invention;

FIG. 2 shows a flow chart of a method for a first communication device according to embodiments of the invention;

FIG. 3 shows a second communication device according to embodiments of the invention;

FIG. 4 shows a flow chart of a method for a second communication device according to embodiments of the invention;

FIG. 5 shows a communication system according to embodiments of the invention;

FIG. 6 shows a first implementation example of the first communication device with FDSS and spectrum extension with shift parameter L;

FIG. 7 shows an implementation example of the second communication device;

FIG. 8 (a) and FIG. 8 (b) and FIG. 8 (c) are a show 99-percentile PAPR [dB] as a function of Nₑ for different constellations, FDSS window and values of L;

FIG. 9 shows 99-percentile PAPR [dB] of QPSK as a function of Nₑ for a fixed N_{data}=96;

FIG. 10(a) and FIG. 10(b) show optimal numbers Nₑ^{(opt)} of REs used for spectrum extension that minimizes the PAPR as a function of the number resource blocks N_{RB}=N_{sc}/12 for the total allocated bandwidth;

FIG. 11 shows optimal numbers Nₑ^{(opt)} of REs used for spectrum extension that minimizes the PAPR with QPSK where N_{data} is fixed compared to the case where N_{sc} is fixed;

FIG. 12 shows some signaling aspects of embodiments of the invention;

FIG. 13 illustrates spectrum-extended data sequence as a function of the shift parameter L with N_{data}=10 symbols and Nₑ=4;

FIG. 14 shows a second implementation example of the first communication device with FDSS and spectrum extension with shift parameter L;

FIG. 15 shows a third implementation example of the first communication device with FDSS and periodic spectrum extension with shift parameter L;

FIG. 16 shows DMRS subcarrier location for DFT-s-OFDM;

FIG. 17 illustrates the RE allocation with three different DMRS design options;

FIG. 18 shows CCDF of PAPR with the three different options of DMRS design, where N_{data}=72 and N_{sc}=96 with RRC window (ρ=0.5, β=−0.65); and

FIG. 19 shows maximum PAPR of Option C as a function of SE size with the three different FDSS window.

### DETAILED DESCRIPTION

Currently in 3GPP NR, FDSS is only implicitly supported for π/2-BPSK uplink transmission through RAN4 requirements limiting the distortion from a FDSS window. Moreover, in current NR, the FDSS window is proprietary and may be different for each UE. Therefore, the SE cannot be predetermined for any user equipment (UE), otherwise the size of the SE for a specific UE may be too large and detrimental in term of PAPR performance. At the same time the resource allocation and signal configuration for each UE is typically scheduled by the base station (BS).

Thus, embodiments of the invention relate to a first communication device 100 and a second communication device 300 solving the issue of conventional solutions, which do not provide the minimum PAPR, since the size of the SE is constant or not optimized with respect to PAPR performance and UE-specific transmission configuration and capability. Moreover, the issue of conventional solutions where the shift of the Fourier coefficients is not selected in order to minimize the PAPR is also solved.

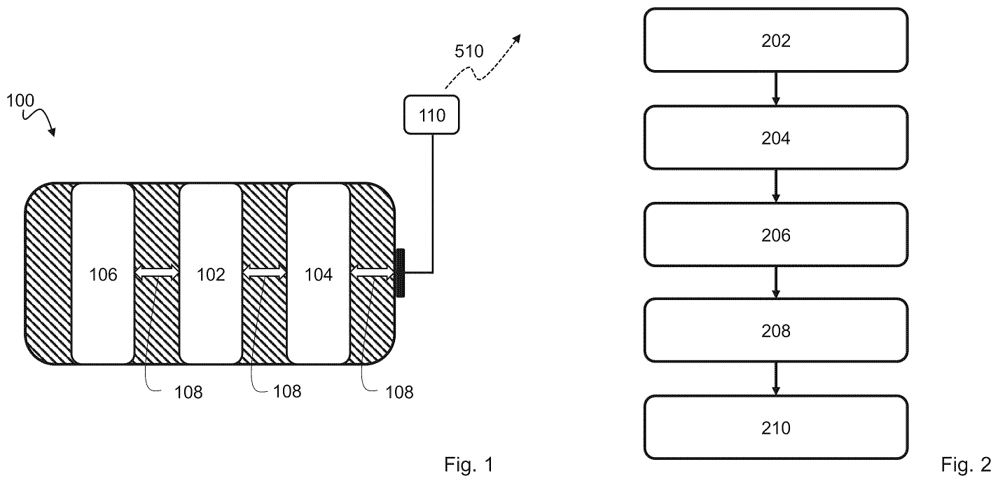

FIG. 1 shows a first communication device 100 according to an embodiment of the invention. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose central processing units (CPUs), one or more digital signal processor (DSPs), one or more application-specific integrated circuit (ASICs), one or more field programmable gate array (FPGAs), one or more programmable logic device, one or more discrete gate, one or more transistor logic device, one or more discrete hardware component, or one or more chipsets. The memory 106 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset. That the first communication device 100 is configured to perform certain actions can in this disclosure be understood to mean that the first communication device 100 comprises suitable means, such as e.g., the processor 102 and the transceiver 104, configured to perform the actions.

According to embodiments of the invention, the first communication device 100 is configured to obtain a N_{data} number of Fourier coefficients based on a N_{data} number of data symbols, wherein N_{data} is a positive integer. The first communication device 100 is further configured to repeat a Nₑ number of Fourier coefficients of the N_{data} number of Fourier coefficients to obtain a N_{sc} number of Fourier coefficients, wherein Nₑ and N_{sc} are positive integers and wherein Nₑ is determined based on at least one of: a modulation symbol constellation of the N_{data} number of data symbols, and a frequency domain spectrum shaping, FDSS, window of the first communication device 100. The first communication device 100 is further configured to multiply the N_{sc} number of Fourier coefficients with a FDSS window of size N_{sc} to obtain N_{sc} number of frequency shaped Fourier coefficients. The first communication device 100 is further configured to map the N_{sc} number of frequency shaped Fourier coefficients on a N_{sc} number of subcarriers to obtain a discrete Fourier transform spread orthogonal frequency division multiplexing, DFT-s-OFDM, signal 510. The first communication device 100 is further configured to transmit the DFT-s-OFDM signal 510.

Furthermore, in an embodiment of the invention, the first communication device 100 for a communication system 500 comprises: a processor configured to: obtain a N_{data} number of Fourier coefficients based on a N_{data} number of data symbols, wherein N_{data} is a positive integer; repeat a Nₑ number of Fourier coefficients of the N_{data} number of Fourier coefficients to obtain a N_{sc} number of Fourier coefficients, wherein Nₑ and N_{sc} are positive integers and wherein Nₑ is determined based on at least one of: a modulation symbol constellation of the N_{data} number of data symbols, and a FDSS window of the first communication device 100; multiply the N_{sc} number of Fourier coefficients with a FDSS window of size N_{sc} to obtain N_{sc} number of frequency shaped Fourier coefficients; map the N_{sc} number of frequency shaped Fourier coefficients on a N_{sc} number of subcarriers to obtain a DFT-s-OFDM signal 510; and a transceiver configured to: transmit the DFT-s-OFDM signal 510.

Moreover, in yet another embodiment of the invention, the first communication device 100 for a communication system 500 comprises a processor and a memory having computer readable instructions stored thereon which, when executed by the processor, cause the processor to: obtain a N_{data} number of Fourier coefficients based on a N_{data} number of data symbols, wherein N_{data} is a positive integer; repeat a Nₑ number of Fourier coefficients of the N_{data} number of Fourier coefficients to obtain a N_{sc} number of Fourier coefficients, wherein Nₑ and N_{sc} are positive integers and wherein Nₑ is determined based on at least one of: a modulation symbol constellation of the N_{data} number of data symbols, and a FDSS window of the first communication device 100; multiply the N_{sc} number of Fourier coefficients with a FDSS window of size N_{sc} to obtain N_{sc} number of frequency shaped Fourier coefficients; map the N_{sc} number of frequency shaped Fourier coefficients on a N_{sc} number of subcarriers to obtain a DFT-s-OFDM signal 510; and transmit the DFT-s-OFDM signal 510.

FIG. 2 shows a flow chart of a corresponding method 200 which may be executed in a first communication device 100, such as the one shown in FIG. 1. The method 200 comprises obtaining 202 a N_{data} number of Fourier coefficients based on a N_{data} number of data symbols, wherein N_{data} is a positive integer. The method 200 further comprises repeating 204 a Nₑ number of Fourier coefficients of the N_{data} number of Fourier coefficients to obtain a N_{sc} number of Fourier coefficients, wherein Nₑ and N_{sc} are positive integers and wherein Nₑ is determined based on at least one of: a modulation symbol constellation of the N_{data} number of data symbols, and a FDSS window of the first communication device 100. The method 200 further comprises multiplying 206 the N_{sc} number of Fourier coefficients with a FDSS window of size N_{sc} to obtain N_{sc} number of frequency shaped Fourier coefficients. The method 200 further comprises mapping 208 the N_{sc} number of frequency shaped Fourier coefficients on a N_{sc} number of subcarriers to obtain a DFT-s-OFDM signal 510. The method 200 further comprises transmitting 210 the DFT-s-OFDM signal 510.

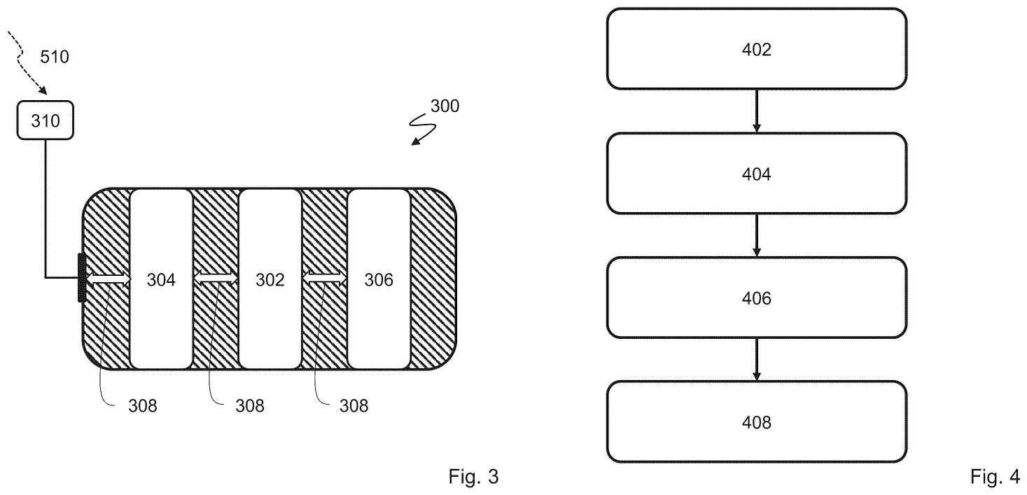

FIG. 3 shows a second communication device 300 according to an embodiment of the invention. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 further comprises an antenna or antenna array 310 coupled to the transceiver 304, which means that the second communication device 300 is configured for wireless communications in a communication system.

The processor 302 may be referred to as one or more general-purpose CPUs, one or more DSPs, one or more ASICs, one or more FPGAs, one or more programmable logic device, one or more discrete gate, one or more transistor logic device, one or more discrete hardware component, one or more chipset. The memory 306 may be a read-only memory, a RAM, or a NVRAM. The transceiver 104 may be a transceiver circuit, a power controller, or an interface providing capability to communicate with other communication modules or communication devices. The transceiver 304, the memory 306 and/or the processor 302 may be implemented in separate chipsets or may be implemented in a common chipset. That the second communication device 300 is configured to perform certain actions can in this disclosure be understood to mean that the second communication device 300 comprises suitable means, such as e.g., the processor 302 and the transceiver 304, configured to perform the actions.

According to embodiments of the invention, the second communication device 300 is configured to receive a DFT-s-OFDM signal 510 from a first communication device 100, the DFT-s-OFDM signal 510 comprising a N_{sc} number of Fourier coefficients mapped on a N_{sc} number of subcarriers, wherein N_{sc} is a positive integer. The second communication device 300 is further configured to obtain the N_{sc} number of Fourier coefficients based on the DFT-s-OFDM signal 510, the N_{sc} number of Fourier coefficients comprising a N_{data} number of Fourier coefficients and a Nₑ number of repeated Fourier coefficients of the N_{data} number of Fourier coefficients, wherein N_{data} and Nₑ are positive integers, and the N_{data} number of Fourier coefficients are obtained based on a N_{data} number of data symbols, and wherein Nₑ is determined based on at least one of a modulation symbol constellation of the N_{data} number of data symbols, and a FDSS window of the first communication device 100. The second communication device 300 is further configured to obtain the N_{data} number of Fourier coefficients based on the N_{sc} number of Fourier coefficients. The second communication device 300 is further configured to decode the N_{data} number of Fourier coefficients to obtain the N_{data} number of data symbols.

Furthermore, in an embodiment of the invention, the second communication device 300 for a communication system 500 comprises: a transceiver configured to: receive a DFT-s-OFDM signal 510 from a first communication device 100, the DFT-s-OFDM signal 510 comprising a N_{sc} number of Fourier coefficients mapped on a N_{sc} number of subcarriers, wherein N_{sc} is a positive integer; and a processor configured to: obtain the N_{sc} number of Fourier coefficients based on the DFT-s-OFDM signal 510, the N_{sc} number of Fourier coefficients comprising a N_{data} number of Fourier coefficients and a Nₑ number of repeated Fourier coefficients of the N_{data} number of Fourier coefficients, wherein N_{data} and Nₑ are positive integers, and the N_{data} number of Fourier coefficients are obtained based on a N_{data} number of data symbols, and wherein Nₑ is determined based on at least one of a modulation symbol constellation of the N_{data} number of data symbols, and a FDSS window of the first communication device 100; obtain the N_{data} number of Fourier coefficients based on the N_{sc} number of Fourier coefficients; and decode the N_{data} number of Fourier coefficients to obtain the N_{data} number of data symbols.

Moreover, in yet another embodiment of the invention, the second communication device 300 for a communication system 500 comprises a processor and a memory having computer readable instructions stored thereon which, when executed by the processor, cause the processor to: receive a DFT-s-OFDM signal 510 from a first communication device 100, the DFT-s-OFDM signal 510 comprising a N_{sc} number of Fourier coefficients mapped on a N_{sc} number of subcarriers, wherein N_{sc} is a positive integer; obtain the N_{sc} number of Fourier coefficients based on the DFT-s-OFDM signal 510, the N_{sc} number of Fourier coefficients comprising a N_{data} number of Fourier coefficients and a Nₑ number of repeated Fourier coefficients of the N_{data} number of Fourier coefficients, wherein N_{data} and Nₑ are positive integers, and the N_{data} number of Fourier coefficients are obtained based on a N_{data} number of data symbols, and wherein Nₑ is determined based on at least one of a modulation symbol constellation of the N_{data} number of data symbols, and a FDSS window of the first communication device 100; obtain the N_{data} number of Fourier coefficients based on the N_{sc} number of Fourier coefficients; and decode the N_{data} number of Fourier coefficients to obtain the N_{data} number of data symbols.

FIG. 4 shows a flow chart of a corresponding method 400 which may be executed in a second communication device 300, such as the one shown in FIG. 3. The method 400 comprises receiving 402 a DFT-s-OFDM signal 510 from a first communication device 100, the DFT-s-OFDM signal 510 comprising a N_{sc} number of Fourier coefficients mapped on a N_{sc} number of subcarriers, wherein N_{sc} is a positive integer. The method 400 further comprises obtaining 404 the N_{sc} number of Fourier coefficients based on the DFT-s-OFDM signal 510, the N_{sc} number of Fourier coefficients comprising a N_{data} number of Fourier coefficients and a Nₑ number of repeated Fourier coefficients of the N_{data} number of Fourier coefficients, wherein N_{data} and Nₑ are positive integers, and the N_{data} number of Fourier coefficients are obtained based on a N_{data} number of data symbols, and wherein Nₑ is determined based on at least one of a modulation symbol constellation of the N_{data} number of data symbols, and a FDSS window of the first communication device 100. The method 400 further comprises obtaining 406 the N_{data} number of Fourier coefficients based on the N_{sc} number of Fourier coefficients. The method 400 further comprises decoding 408 the N_{data} number of Fourier coefficients to obtain the N_{data} number of data symbols.

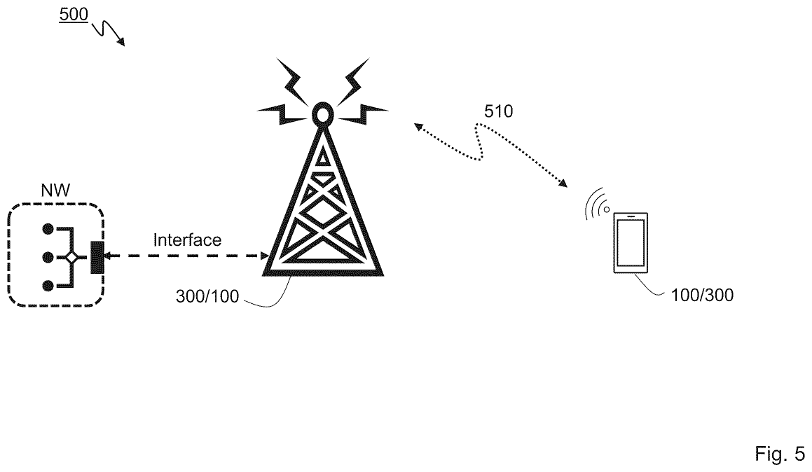

FIG. 5 shows a communication system 500 according to embodiments of the invention. The communication system 500 in the disclosed example comprises a first communication device 100 and a second communication device 300 configured to communicate and operate in the communication system 500. For simplicity, the shown communication system 500 only comprises one first communication device 100 and one second communication device 300. However, the communication system 500 may comprise any number of first communication devices 100 and any number of second communication devices 300 without deviating from the scope of the invention.

The first communication device 100 is configured to generate and transmit a DFT-s-OFDM signal 510 according to the disclosed solution in the communication system 500. The second communication device 300 is thus configured to receive the DFT-s-OFDM signal 510 transmitted by the first communication device 100. The mentioned communication system 500 is any suitable communication system such as 3GPP 5G NR or 6G. The first communication device 100 may also be denoted a transmitter device or simply a transmitter and may be a client device such as a UE. Correspondingly, the second communication device 300 may also be denoted receiver device or simply a receiver and may be network access node such as a BS. The network access node may be connected to a network (NW) such as a core network via a communication interface. However, embodiments of the invention are also applicable when the transmitter is a base station and the receiver is a UE, i.e., the revers case. Moreover, embodiments of the invention are also applicable to other network nodes, such as repeaters, relays, etc. Furthermore, embodiments of the invention are further applicable to direct communication between UEs such as over the sidelink (SL) interface.

To provide even deeper understanding of the disclosed solution signal definitions are hereby presented in the following section in which we consider a DFT-s-OFDM signal s[n] with SE which carries N_{data} constellation symbols, using a total of N_{sc}=N_{data}+Nₑ OFDM subcarriers where Nₑ is a number of subcarriers used for symbol repetition only for the purpose of PAPR reduction. We assume for simplicity of illustration and in relation with the symmetric nature of practical FDSS window that Nₑ is an even integer. Nevertheless, the disclosed solution is straightforwardly generalizable to when Nₑ is odd, by assuming e.g., a left SE of [Nₑ/2] and right SE of [Nₑ/2], or vice-versa.

The low-pass equivalent time-discrete DFT-s-OFDM signal representation is defined for samples 0≤n≤N_{fft}−1 by

$$s [ n ] = \frac{1}{\sqrt{{N}_{sc} {N}_{data}}} {\sum }_{k = 0}^{{N}_{sc} - 1} W [ k ] X [ k + L ( mod {N}_{data} ) ] {e}^{j \frac{2 π}{{N}_{fft}} nk} \qquad ( 1 )$$

with frequency-domain symbols

$$X [ k ] = \frac{1}{\sqrt{{N}_{data}}} {\sum }_{m = 0}^{{N}_{data} - 1} x [ m ] {e}^{- j \frac{2 π}{{N}_{data}} k m} \qquad ( 2 )$$

where
   N_{fft} is the IFFT size of the OFDM modulation.
   N_{data} is the number of modulation constellation symbols.
   N_{sc}=Nₑ+N_{data} is the total number of OFDM subcarriers.
   Nₑ is the number of subcarriers used for SE, which we refer also to as the size of SE.
   {W[0], . . . , W[N_{sc}−1]} are the FDSS window coefficients.
   L is the Fourier coefficient shift parameter.
   (mod N) is the modulo-N operator.

It may be noted that other types of normalization factors than and

$$\frac{1}{\sqrt{{N}_{sc} {N}_{data}}} and \frac{1}{\sqrt{{N}_{data}}}$$

could be used in Eq. (1) and (2). Typically, W[k] are real-valued, but embodiments of the invention are not limited to this and complex-valued FDSS could be used. Embodiments of the invention further includes the case where W[k]=1.

Thus, according to embodiments of the invention cyclically shifting with shifting parameter L may also introduced. This means that the first communication device 100 is according to embodiments configured to, previous to multiplying the N_{sc} number of Fourier coefficients with the FDSS window: cyclically shift the N_{sc} number of Fourier coefficients with a L number of Fourier coefficients to obtain N_{sc} number of cyclically shifted Fourier coefficients, wherein L is a positive integer; and to multiply the N_{sc} number of cyclically shifted Fourier coefficients with the FDSS window of size N_{sc} to obtain N_{sc} number of frequency shaped and cyclically shifted Fourier coefficients. The first communication device 100 finally maps the N_{sc} number of frequency shaped and cyclically shifted Fourier coefficients on the N_{sc} number of subcarriers to obtain the DFT-s-OFDM signal 510.

Correspondingly, the second communication device 300 is according to embodiments configured to, previous to obtain the N_{data} number of Fourier coefficients: cyclically shift (in the opposite direction to the direction done in the first communication device 100) the N_{sc} number of Fourier coefficients with a L number of Fourier coefficients to obtain N_{sc} number of cyclically shifted Fourier coefficients, wherein L is a positive integer; and to obtain the N_{data} number of Fourier coefficients based on the N_{sc} number of cyclically shifted Fourier coefficients.

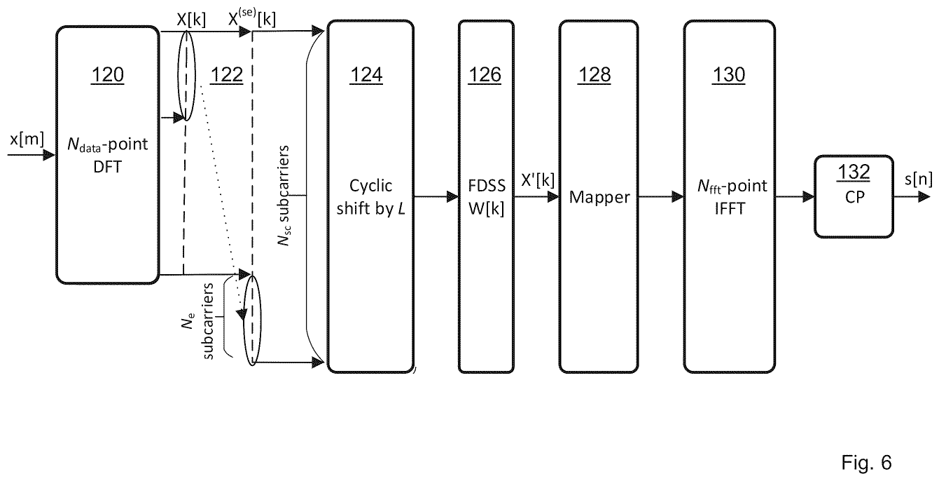

A first implementation example of such as first communication device 100 is shown in the block diagram of FIG. 6. Further implementation examples of the first communication device 100 are presented in the following sections. With reference to FIG. 6, the first communication device 100 comprises a N_{data}-point DFT block 120 configured to receive a N_{data} number of data symbols (x[m]) and output N_{data} number of Fourier coefficients based on the N_{data} number of data symbols. The first communication device 100 further comprises a SE block 122 which is configured to repeat a Nₑ number of Fourier coefficients of the N_{data} number of Fourier coefficients to provide a N_{sc} number of Fourier coefficients which are fed to the cyclically shifting block 124. The N_{sc} number of Fourier coefficients are thus cyclically shifted in the cyclically shifting block 124 with a L number of Fourier coefficients to output N_{sc} number of cyclically shifted Fourier coefficients which are fed to the FDSS block 126. The N_{sc} number of cyclically shifted Fourier coefficients are thereafter multiplied with the FDSS window of size N_{sc} in the FDSS block 126 to output N_{sc} number of frequency shaped and cyclically shifted Fourier coefficients (X′[k]) which are fed to the mapper block 128. In the mapper block 128, the N_{sc} number of frequency shaped and cyclically shifted Fourier coefficients are mapped on a N_{sc} number of subcarriers among N_{fft} subcarriers to output a DFT-s-OFDM signal of N_{fft} coefficients in the frequency domain which is converted into the time domain in the IFFT block 130. Additionally, a cyclic prefix (CP) may be added in the CP block 132. The DFT-s-OFDM signal with CP is thereafter transmitted in the communication system 500 as signal s[n].

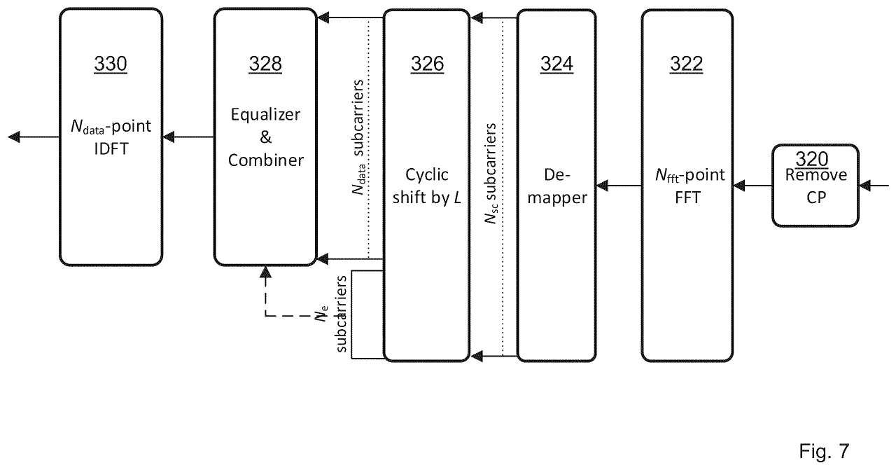

An implementation example of a corresponding second communication device 300 is shown in the block diagram of FIG. 7. The received DFT-s-OFDM signal 510 is first demodulated by a CP-removal step in the CP removal block 320 and thereafter fed to the FFT block 322 which provides N_{fft} subcarriers coefficients. The demapper block 324 thereafter selects N_{sc} number of Fourier coefficients among these N_{fft} subcarriers according to the bandwidth allocation of the first communication device 100. The selected N_{sc} Fourier coefficients are fed to the cyclical shifting block 326 to be cyclically shifted with a L number of Fourier coefficients to provide N_{data} number of Fourier coefficients. A common method to mitigate the transmission channel fading and the FDSS window attenuation is to perform equalization on the N_{data} number of Fourier coefficients which is performed in the equalization and combiner block 328. For further improvement, and depending on whether the repeated symbols were included or added in the allocated resources for the transmission of the DFT-s-OFDM signal, the equalization and combiner block 328 may also be inputted with the Nₑ number of Fourier coefficients corresponding to the repeated symbols. A Fourier coefficient received from the in-band and its repeated version received from the spectral extension can for example be co-phased and summed before equalization, thus providing combining and frequency-diversity gains. Finally, the N_{data} number of equalized Fourier coefficients are fed to the N_{data}-point inverse DFT (IDFT) block 330 which is configured to precode the N_{data} number of equalized Fourier coefficients to provide N_{data} number of demodulated data symbols which are sent to a decoder block for decoding (not shown in FIG. 7).

Given a FDSS window, both parameters Nₑ and L will impact the PAPR performance. Here we disclose how to carefully choose these parameters to reach the best PAPR reduction. Specially, we will show that:
1. When using SE, i.e., Nₑ>0, the PAPR typically decreases but only up to an optimum Nₑ^{(opt)} and then increases again. Therefore, selecting a too large Nₑ can be detrimental not only for spectrum efficiency but also from a PAPR reduction perspective. This non-trivial optimum depends mainly on the FDSS window, but also on the shift value L, modulation symbol constellation of the N_{data} number of data symbols, and bandwidth allocation.
2. The value of L providing the lowest PAPR depends on modulation symbol constellation of the N_{data} number of data symbols, the extension size Nₑ and the number of constellation symbols i.e., N_{data}=N_{sc}−Nₑ.
   Existence of a Global Optimal Nₑ^{(Opt)} Minimizing the PAPR

It is known that SE can further reduce the PAPR on top of FDSS. However, it is not known that there is an optimum SE size Nₑ^{(opt)} that minimizes the PAPR, and so that a too large SE may even increase the PAPR. Therefore, the SE size should be better selected such that Nₑ≤Nₑ^{(opt)}, i.e., less than Nₑ^{(opt)} which corresponds to a specific SE capability of the first communication device 100 as a transmitter. We will see that the exact Nₑ^{(opt)} specific to each transmitter depends on the FDSS window, L, and N_{sc} and N_{data}. Note that selecting Nₑ≤Nₑ^{(opt)} may also be desired for mitigating the spectral efficiency reduction of SE at the cost of slightly larger PAPR. Selecting Nₑ≤Nₑ^{(opt)} may also be necessary by the system configuration to e.g., constrain Nₑ to be a factor of 12 subcarriers for having an integer number of RB.

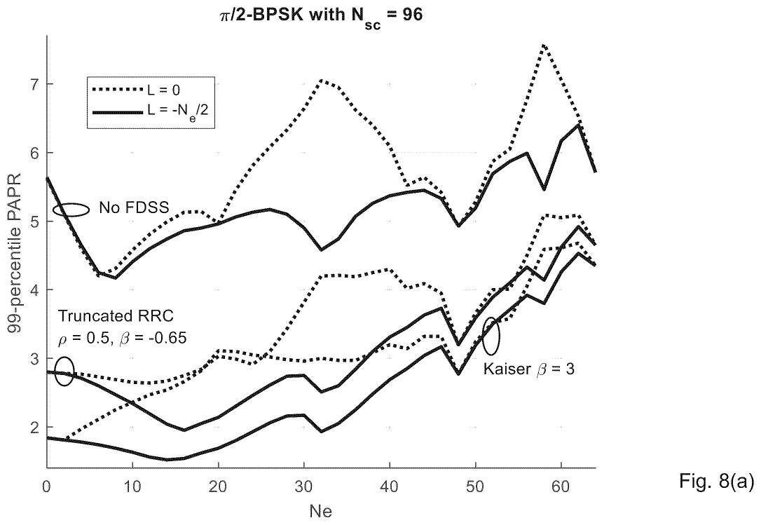

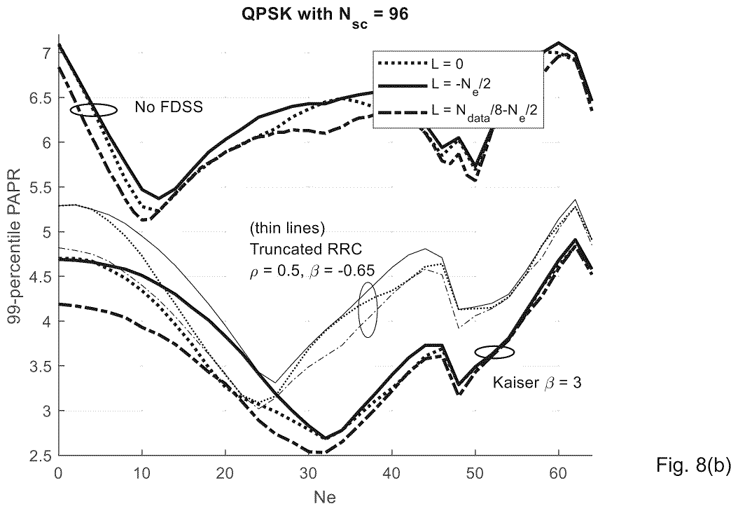

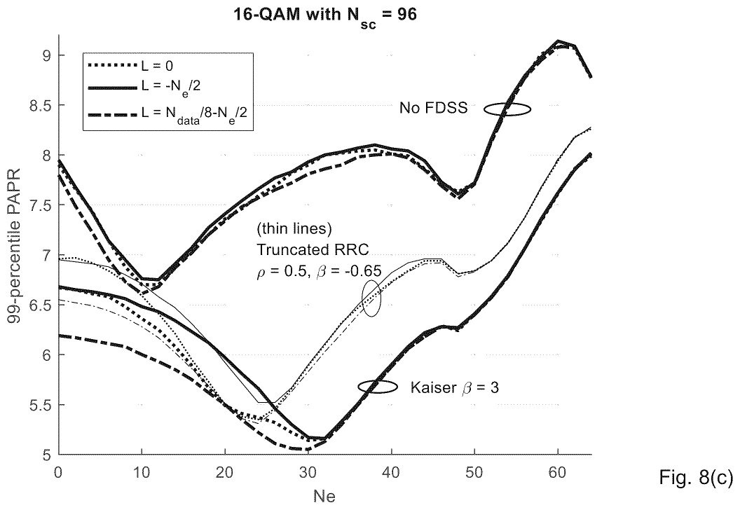

In FIGS. 8 (a)-(c), we plot the 99-percentile PAPR as a function of the number of SE subcarriers Nₑ while the total bandwidth is kept fixed to N_{sc}=96. This is plotted for different filters, modulation symbol constellations and shift values L. In all these numerical comparison, two FDSS windows are considered i.e.,: i) a Kaiser window with β=3, and ii) a truncated RRC window with ρ=0.5, β=−0.65. The shift rules L=0 and

$$L = - \frac{{N}_{e}}{2}$$

from conventional solutions are used. We will show in the following sections why parameter

$$L = - \frac{{N}_{e}}{2}$$

is closest to the best shift method for π/2-BPSK. For QAM constellations, we use also

$$L = ( \frac{{N}_{data}}{8} - \frac{{N}_{e}}{2} )$$

which we will also show later why it is close to the best shifting for QPSK.

FIGS. 8 (a)-(c) show that the resulting PAPR is neither a linear nor a continuously decreasing function as a function of Nₑ. There thus exists for all cases an optimum SE size Nₑ^{(opt)} that minimizes the PAPR from which a further increase of SE would become detrimental. Therefore, the SE size should preferably be selected such that Nₑ≤Nₑ^{(opt)}, where Nₑ^{(opt)} can be predetermined based on the transmission configuration such as the FDSS window, the shift parameter L, the modulation symbol constellation and the bandwidth allocation. It may also be noted from FIGS. 8 (a)-(c) that even without FDSS, a large reduction of PAPR can be obtained from SE.

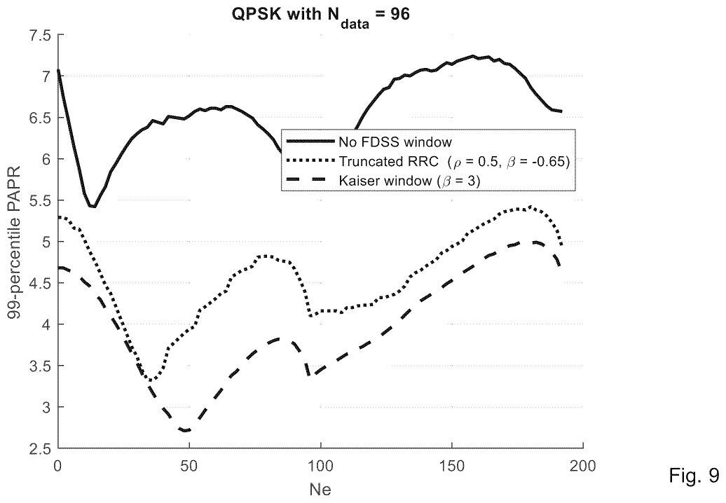

In simulations, for a given total bandwidth N_{sc} we increased the value of Nₑ and thus decreased the value of N_{data} such that Nₑ+N_{data}=N_{sc}. Therefore, the SE was performed inside the given total bandwidth of N_{sc} subcarriers. Alternatively, one could consider optimizing the best Nₑ such that we fix N_{data} and increase the total bandwidth N_{sc}. FIG. 9 compares the PAPR for different Nₑ where N_{data}=96 is fixed, with QPSK and

$$L = - \frac{{N}_{e}}{2} .$$

It can be observed from FIG. 9 that the curves look of similar shapes than for N_{sc} fixed, and notably also show a global optimum.
FDSS Window and Convergence of Nₑ^{(opt})/N_{sc} as N_{sc} Grows

The global optimum of SE size Nₑ^{(opt)} mainly depends on the FDSS window design. In fact, Nₑ^{(opt)} appears to converge to a percentage of N_{sc} as N_{sc} grows for a given FDSS window. This means that to achieve similar PAPR reduction Nₑ should be linearly increased with the bandwidth allocation N_{sc} or N_{data}. Therefore Nₑ must better be determined also a function of N_{sc}, or equivalently N_{data}. In other words, Nₑ is in embodiments determined further based on parameters N_{sc} or N_{data}.

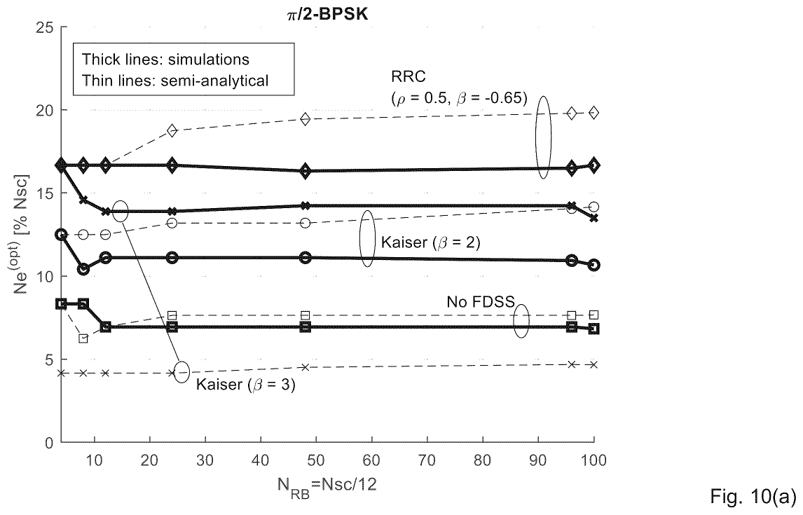

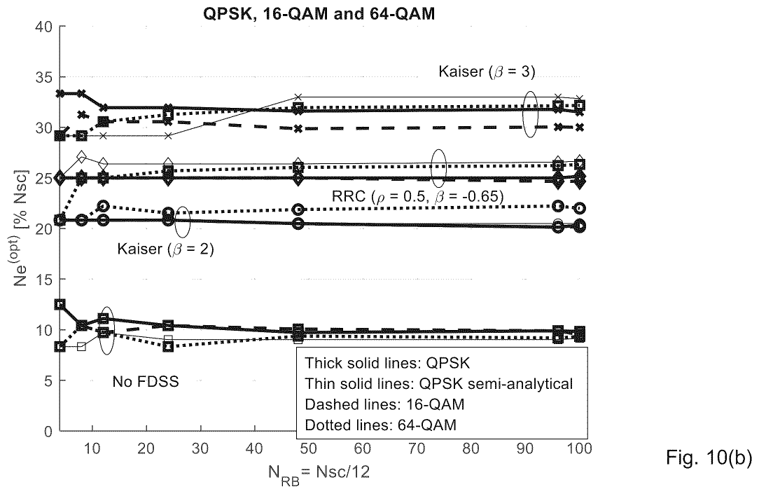

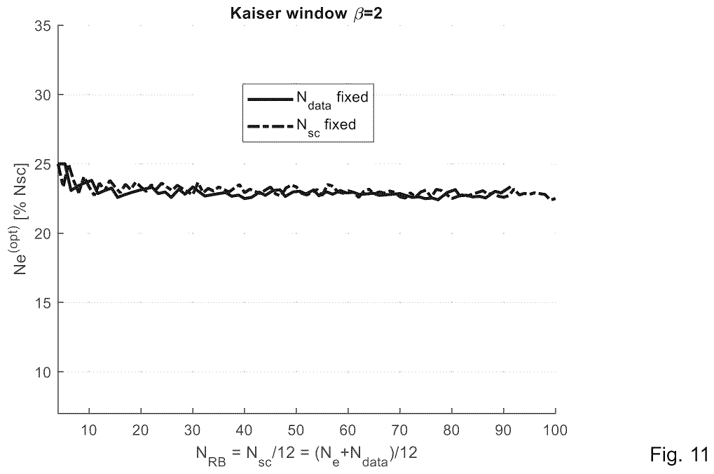

FIGS. 10 (a) and (b) show the numerically found Nₑ^{(opt)} in percentage of N_{sc} as a function of N_{RB}=N_{sc}/12 for different FDSS windows. The numerically found Nₑ^{(opt)} is expressed in percentage of N_{sc} as a function of N_{RB}=4, 8, 12, 24, 48, 96, and 100. For a given modulation symbol constellation, one can see that the optimal Nₑ^{(opt)} may be very different depending on the FDSS window. The lowest possible PAPR is obtained for values of Nₑ that ranges in these examples between 7%-35% of the total bandwidth allocation. In general, the more edge attenuation a FDSS window provides, the lower the PAPR is and the largest optimum value Nₑ^{(opt)} is. More importantly, for each FDSS window, the optimum SE size Nₑ^{(opt)} appears to be almost a constant fraction of N_{sc} as N_{sc} grows.

Moreover, the obtained optimum Nₑ^{(opt)} with N_{data} fixed is plotted in FIG. 11 as a percentage of the resulting N_{sc}=N_{data}+Nₑ^{(opt)}. Here QPSK modulation is used with

$$L = - \frac{{N}_{e}}{2}$$

and a FDSS Kaiser window with β=2. This is compared to the obtained Nₑ^{(opt)} as a percentage of N_{sc} when N_{sc} is fixed. As it can be observed the optimization Nₑ^{(opt)} with N_{data} fixed leads to very similar ratio Nₑ^{(opt)}/(N_{data}+Nₑ^{(opt)}) compared to the optimization Nₑ^{(opt)}/N_{sc} with N_{sc} fixed. It is also noted that in the case of N_{data} fixed, it could be more natural to express the optimum SE size as the ratio Nₑ^{(opt)}/N_{data} with would be obviously a different ratio than Nₑ^{(opt)}/N_{sc}. In general, the two ratios are always related as follows: assume

$$\frac{{N}_{e}^{( opt )}}{{N}_{sc}} = X$$

then equivalently

$$\frac{{N}_{e}^{( opt )}}{{N}_{data}} = \frac{X}{1 - X} .$$

Semi-Analytical Approximation of Nₑ^{(opt)}

The optimum SE size Nₑ^{(opt)} minimizing the PAPR can also be verified and approximated by a semi-analytical numerical search.

Thus, we start by reformulating the signal as a time-duplexing of multiple pulses {gₘ[n]}ₘ₌₀^{N}^{_{data}}⁻¹. By inserting Eq. (2) in (1), we obtain,

$$s [ n ] = \frac{1}{\sqrt{{N}_{sc} {N}_{data}}} {\sum }_{m = 0}^{{N}_{data} - 1} x [ m ] \underbrace{h [ n - \frac{{N}_{fft}}{{N}_{data}} m ] {e}^{- j \frac{2 π L}{{N}_{data}} m}}_{{g}_{m} [ n ]} \qquad ( 3 )$$

where the pulse-shaping filter is:

$$h [ n ] = {\sum }_{k = 0}^{{N}_{sc} - 1} W [ k ] {e}^{j \frac{2 π k}{{N}_{fft}} n} \qquad ( 4 )$$

In the case of no FDSS windowing, W[0]==W[N_{sc}−1]=1, this further reduces to the conventional DFT-s-OFDM pulse, in the form of a Dirichlet kernel, with N_{sc} modulated subcarriers:

$$h [ n ] = {e}^{j \frac{π}{{N}_{fft}} n ( {N}_{sc} - 1 )} \frac{sin ( π \frac{{N}_{sc}}{{N}_{fft}} n )}{sin ( π \frac{1}{{N}_{fft}} n )} \qquad ( 5 )$$

Using this pulse formulation and adapting the bound, we get the following bounds for ϕ-rotate BPSK on our system as

$$PAPR \leq {max}_{n} \{ \begin{matrix}\frac{{N}_{fft} {N}_{sc}}{{N}_{data} {P}_{W}} {\sum }_{i , j = 0}^{{N}_{data} - 1} \vert {g}_{i} [ n ] \vert \vert {g}_{j} [ n ] \vert \\ \vert cos ( ( i - j ) ( ϕ - \frac{2 L + {N}_{e} - 1}{{N}_{data}} π ) ) \vert\end{matrix} \} {=}^{Δ} {\overline{PAPR}}^{ϕ - BPSK} \qquad ( 6 )$$

where P_{W}=Σₖ₌₀^{N}^{_{sc}}⁻¹W[k]² is the norm square of the FDSS window.

For π/2-BPSK, we specifically have ϕ=π/2. Moreover, choosing L=−Nₑ/2, which is the best shifting method, it follows that

$$\frac{2 L + {N}_{e} - 1}{{N}_{data}} π = \frac{- 1}{{N}_{data}} π \approx 0 .$$

Hence, the bound of Eq. (6) become approximatively equal to

$${\overline{PAPR}}^{ϕ - BPSK} \approx {max}_{n} \{ \frac{{N}_{fft} {N}_{s c}}{{N}_{data} {P}_{W}} {\sum }_{i , j = 0}^{{N}_{data} - 1} \vert {g}_{i} [ n ] \vert \vert {g}_{j} [ n ] \vert \vert cos ( \frac{( i - j ) π}{2} ) \vert \} \\ = {max}_{n} \{ \frac{{N}_{fft} {N}_{sc}}{{N}_{data} {P}_{W}} {\sum }_{{i , j = 0}_{( i - j ) odd}}^{{N}_{data} - 1} \vert {g}_{i} [ n ] \vert \vert {g}_{j} [ n ] \vert \} {=}^{Δ} {\overline{PAPR}}^{π / 2 - BPSK} \qquad ( 7 )$$

Note that in the case Nₑ is allowed to be an odd integer, equality would hold with L=−(Nₑ−1)/2.

For QPSK, and in fact any PSK modulation, we can derive a similar bound. The bound becomes

$$PAPR \leq {max}_{n} \{ \frac{{N}_{fft} {N}_{sc}}{{N}_{data} {P}_{W}} {\sum }_{i , j = 0}^{{N}_{data} - 1} \vert {g}_{i} [ n ] \vert \vert {g}_{j} [ n ] \vert \} {=}^{Δ} {\overline{PAPR}}^{QPSK} \qquad ( 8 )$$

By using |cosθ|≤1, on can directly verify that P̅A̅P̅R̅O̅^{ϕ-BPSK}≤P̅A̅P̅R̅^{QPSK}. Moreover, if ϕ=0 as in normal BPSK and if one can have L=−(Nₑ−1)/2, these two bounds become the same: P̅A̅P̅R̅^{(ϕ=0)-BPSK}=P̅A̅P̅R̅^{QPSK}.

In order to compute these bounds, we need to find a maximum over N_{fft} time samples. Nevertheless, the computation complexity of this step can be greatly reduced by remarking that the functions inside the max-operator are periodic so that it is enough to compute only

$$⌈ \frac{{N}_{fft}}{{N}_{data}} ⌉$$

samples to find the maximum value over n.

The bounds in Eq. (7) and (8) may be compared by simulated 99-percentile PAPR. The bounds in Eq. (7) and (8) are not tight, but nevertheless these bounds appear to preserve roughly the position of the optimum SE size minimizing the PAPR. Therefore, we can numerically search the value Nₑ minimizing these bounds to approximate the optimum SE size. This is shown in FIGS. 10 (a) and (b) where we see that this semi-analytical approximation of Nₑ^{(opt)} is often very close and at worst within a 5% gap, except for the case of π/2-BPSK with Kaiser window (β=3). For this specific case, the semi analytical search is very far away from the numerical search and appears to correspond to the location of the minimum PAPR with L=0, see FIG. 8(a). The issue in this case it that SE extension is able to only provide a decrease of PAPR of maximum 0.32 dB to the already very low PAPR of 1.84 dB without SE. The resulting bound is accordingly very flat for a large range of values without a very sharp minimum.

We provide also complementary intuitive explanation of the existence of this optimum SE size using the equivalent pulse-shaping formulation. The upper bound in Eq. (8) can be reformulated as

$$PAPR \leq \frac{{N}_{fft} {N}_{sc}}{{N}_{data} {P}_{W}} {( {max}_{n} \{ {\sum }_{i = 0}^{{N}_{data} - 1} \vert {g}_{i} [ n ] \vert \} )}^{2} . \qquad ( 9 )$$

The coefficient

$$\frac{{N}_{fft} {N}_{sc}}{{N}_{data} {P}_{W}} = \frac{{N}_{fft} {N}_{sc}}{( {N}_{sc} - {N}_{e} ) {P}_{W}} = \frac{{N}_{fft} ( {N}_{data} + {N}_{e} )}{{N}_{data} {P}_{W}}$$

systematically increases when Nₑ increases. However,

$${( {max}_{n} \{ {Σ}_{i = 0}^{{N}_{data} - 1} \vert {g}_{i} [ n ] \vert \} )}^{2}$$

which is the square of the maximum coherent combining of the pulses, may decrease or increase as a function of Nₑ. With a typical windowing function W[k] as described above, the pulse-shaping filters |gᵢ[n]| remain essentially of sinc-shape but with more or less attenuated side lobes. The number of pulses is N_{data}, as given from Eq. (3), and their time separation is

$$\frac{{N}_{f f t}}{{N}_{data}}$$

samples. Through Eq. (4), we further observe that the pulse shape only depends on the FDSS window and the total number of allocated subcarriers N_{sc}. If we fix the value of N_{sc} there will be N_{data}=(N_{sc}−Nₑ) pulses separated apart by

$$\frac{{N}_{f f t}}{{N}_{d a t a}} = \frac{{N}_{f f t}}{{N}_{s c} - {N}_{e}}$$

samples, i.e., the pulse shape does not change by increasing Nₑ but the time-separation between the pulses increases. How much the pulse lobes overlap depends on the FDSS design, in any case an increased time-separation will play on this overlap, helping to reduce the peak power of the signal.

If we would instead fix the value N_{data}, N_{sc} will increase as Nₑ increases and there will be N_{data} pulses separated apart by

$$\frac{{N}_{f f t}}{{N}_{data}}$$

samples. Reciprocally in this case, the pulse shape of Eq. (5) without FDSS will become narrower, since the width of the main lobe is

$$2 \frac{{N}_{fft}}{{N}_{sc}}$$

samples. The narrower pulses will also help to reduce the peak power of the signal. In any case, the FDSS window will have to be designed for a bandwidth of N_{sc} subcarriers.

### Modulation Symbol Constellation

In embodiments of the invention, the modulation symbol constellation of the N_{data} number of data symbols is a π/2-BPSK constellation or a QAM constellation. In the case of the modulation symbol constellations QPSK, 16-QAM and 64-QAM, the optimum Nₑ^{(opt)} appears to be very close to each other when employing the same FDSS window as shown in FIG. 10(b). The largest difference is 1.5% between 16-QAM and QPSK with Kaiser window (β=3). For several cases, the difference is unnoticeable. Therefore, a good rule of thumb is to select for 16-QAM and 64-QAM the same Nₑ as for QPSK. Table 1 below highlights the difference between the selection of Nₑ^{(opt)} with π/2-BPSK and QAMs constellations.

TABLE 1
Numerical selection of Nₑ^{(opt)} according to FIG. 10

| Nₑ^{(opt)}/N_{sc} | π/2 - BPSK | QAMs |
|---|---|---|
| no FDSS | 7% | 10% |
| Kaiser window (β = 2) | 11% | 21% |
| RRC (ρ = 0.5, β = −0.65) | 16% | 25% |
| Kaiser window (β = 3) | 14% | 30% |

As it can be seen form Table 1, the optimum PAPR with π/2-BPSK is obtained with much smaller Nₑ value than with QPSK for the same FDSS window. A good rule of thumb for π/2-BPSK to get significant PAPR reduction is to select

$${N}_{e} \leq \frac{1}{2} {N}_{e}^{( o p t , Q P S K )}$$

where Nₑ^{(opt,QPSK)} is the optimum for QPSK, because

$$\frac{1}{2} {N}_{e}^{( o p t , Q P S K )} ≲ {N}_{e}^{( opt , \frac{π}{2} - BPSK )} .$$

Therefore, in summary the selection of Nₑ for all constellations can be derived from one single value of Nₑ^{(opt)}.

### Shift Parameter L

In FIG. 8 (a) and FIG. 8 (b) and FIG. 8 (c), we see that the shifting method

$$L = ( \frac{{N}_{data}}{8} - \frac{{N}_{e}}{2} )$$

derived in this disclosure provides the best PAPR, and

$$L = - \frac{{N}_{e}}{2}$$

from conventional solutions the worst PAPR. One may find that these two shifting methods reach their optimum for a similar value of SE size Nₑ^{(opt)}. With

$$L = ( \frac{{N}_{data}}{8} - \frac{{N}_{e}}{2} ) ,$$

the optimum SE size can be slightly reduced by 1-2% of N_{sc} compared to

$$L = - \frac{{N}_{e}}{2} .$$

We now explain why the best shifting method is

$$L = - \frac{{N}_{e}}{2}$$

### for π/2-BPSK; and

$$L = \frac{1}{8} {N}_{d a t a} - \frac{{N}_{e}}{2}$$

for QPSK and other QAMs constellation. Starting from the multicarrier signal in Eq. (3), the phase difference between two neighboring pulses of indices m and (m+1) is

$$∠ \frac{{g}_{m + 1} [ n ]}{{g}_{m} [ n ]} = - \frac{2 π L}{{N}_{d a t a}} + ∠ \frac{h [ n - \frac{{N}_{f f t}}{{N}_{d a t a}} ( m + 1 ) ]}{h [ n - \frac{{N}_{f f t}}{{N}_{d a t a}} m ]} \qquad ( 10 )$$

Then, if the FDSS window is real and symmetric we have by using

$$∠ \frac{h [ n - \frac{{N}_{f f t}}{{N}_{d a t a}} ( m + 1 ) ]}{h [ n - \frac{{N}_{f f t}}{{N}_{d a t a}} m ]} = - \frac{( {N}_{s c} - 1 )}{{N}_{d a t a}} π + \{ 0 or π \} \qquad ( 11 )$$

This can also be directly verified to hold true for the special case of no FDSS of Eq. (2).

Therefore, we get the pulsed phase difference

$$\begin{matrix}∠ \frac{{g}_{m} [ n ]}{{g}_{m + 1} [ n ]} = - \frac{2 π}{{N}_{d a t a}} ( L + \frac{( {N}_{s c} - 1 )}{2} ) ( mod π ) \\ = - \frac{2 π}{{N}_{d a t a}} ( L + \frac{( {N}_{e} - 1 )}{2} ) ( mod π )\end{matrix} \qquad ( 12 )$$

The purpose of the rotated-constellation design as π/2-BPSK is to ensure that BPSK symbol of neighboring pulse are transmitted with a phase different of almost π/2 (mod π), such their maximum power combining is minimized.

For π/2-BPSK, the best value of L is found such that Eq. (12) is the closest to zero, i.e.,

$$L \approx - \frac{( {N}_{e} - 1 )}{2} .$$

If Nₑ is an odd integer, then

$$L = - \frac{( {N}_{e} - 1 )}{2}$$

provides the best performance. If Nₑ is an even integer, then

$$L = - \frac{{N}_{e}}{2}$$

as in [7] or

$$L = - \frac{( {N}_{e} - 2 )}{2}$$

provides the best performance. Therefore, as it was shown in FIG. 8(a), selecting a shifting method close to

$$L \approx - \frac{( {N}_{e} - 1 )}{2} ,$$

provide a much better PAPR performance than L=0.

For QPSK and other QAMs, choosing

$$L \approx - \frac{( {N}_{e} - 1 )}{2}$$

is sub-optimal and better PAPR can almost always be found with other L. Notably, the lowest PAPR is obtained by creating a phase difference between neighboring pulses close to π/4 (mod π/2). Namely, one should get

$$- \frac{2 π}{{N}_{data}} ( L + \frac{( {N}_{e} - 1 )}{2} ) \approx \frac{π}{4} ( mod \frac{π}{2} ) . \qquad ( 13 )$$

Therefore, the best PAPR can always be achieved by selecting L approximately equal to

$$L \approx \frac{( 2 k + 1 )}{8} {N}_{data} - \frac{( {N}_{e} - 1 )}{2} . \qquad ( 14 )$$

where k is an integer as then the shift by L leads to a phase difference among data symbols which is always close to π/4.

This is why in FIGS. 8(b) and (c), the PAPR was the worst with

$$L = - \frac{{N}_{e}}{2}$$

and the best

$$L = \frac{{N}_{data}}{8} - \frac{{N}_{e}}{2} .$$

The other value from conventional solutions L=0 provides a trade-off between these two previous L values as it reduces to the other two methods when i) either Nₑ=0, then

$$L = - \frac{{N}_{e}}{2} = 0 ,$$

or ii) either when Nₑ=N_{sc}/5 which is equivalent to

$${N}_{e} = \frac{{N}_{data}}{4} ,$$

and then

$$L = \frac{{N}_{data}}{8} - \frac{{N}_{e}}{2} = 0 .$$

Therefore, L=0 provides close to the best performance only when Nₑ≈20% of N_{sc}.

The gain of the using

$$L = \frac{{N}_{data}}{8} - \frac{{N}_{e}}{2}$$

compared to conventional solutions can be up to 0.6 dB specially when the SE size Nₑ is less than the optimum Nₑ^{(opt)} as it can be seen from in FIGS. 8(b) and (c). We recall that selecting Nₑ≤Nₑ^{(opt)} may actually be desired for example for mitigating the spectral efficiency reduction of SE or constraining Nₑ to be a factor of 12 subcarriers for having an integer number of RB.

In summary, in order to achieve the best PAPR reduction L should be different for some modulation symbol constellation as shown above between π/2-BPSK and QAMs. L should also be determined based on Nₑ and depending on the modulation symbol constellation also possibly based on N_{data} or N_{sc}. Precisely, with QAM, the best PAPR values are achieved with

$$L = round ( \frac{( 2 k + 1 )}{8} {N}_{data} - \frac{( {N}_{e} - 1 )}{2} ) , or L = ⌈ \frac{( 2 k + 1 )}{8} {N}_{data} - \frac{( {N}_{e} - 1 )}{2} ⌉ , or L = ⌊ \frac{( 2 k + 1 )}{8} {N}_{data} - \frac{( {N}_{e} - 1 )}{2} ⌋ or L = round ( {N}_{data} - \frac{( {N}_{e} - 1 )}{2} ) , or L = ⌈ {N}_{data} - \frac{( {N}_{e} - 1 )}{2} ⌉ , or L = ⌊ {N}_{data} - \frac{( {N}_{e} - 1 )}{2} ⌋ ,$$

where k is a positive integer k, where round(x) gives the closest integer to x, and where [x] and [x] are the ceiling and floor operators on x, respectively.

### Signaling Aspects

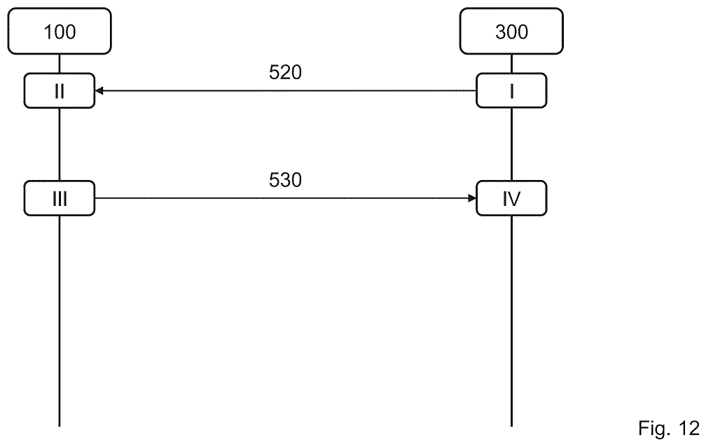

FIG. 12 illustrates signaling aspects according to embodiments of the invention, since based on the gains presented in the previous sections, the disclosed solution assumes that the number of subcarriers for the SE, Nₑ, is based on the FDSS capability of the first communication device 100, and possibly other transmission configurations such as but not limited to:
The total number of allocated subcarriers, N_{sc}, or the number of subcarriers containing data symbols, N_{data}.
The Fourier coefficient shift parameter of L subcarriers.
The modulation symbol constellation.

Both the transmitter (e.g., UE) and the receiver (e.g., base station) need to be aware of the selected values of parameters Nₑ and L. Such information could be provided by control signaling between the first communication device 100 (i.e., the transmitter) and the second communication device 300 (i.e., the receiver). The control signaling may e.g., be performed through higher protocol layers such as radio resource control (RRC) signaling or medium access control (MAC) signaling. This is beneficial if the parameters do not need to change in a dynamic fashion. Another option is to signal through the physical layer, e.g., via the control channels. The benefit of this is that the parameters can be changed instantly. Combinations of higher layer signaling and physical layer signaling could also be used, e.g., certain values of Nₑ and L are configured by higher layers and physical layer signaling selects among these values.

With reference to step I in FIG. 12, the second communication device 300 transmits a first control signal 520 to the first communication device 100. The first control signal 520 indicates parameter Nₑ and/or L. In step II in FIG. 12, the first communication device 100 is configured to receive the first control signal 520 indicating Nₑ and/or L from the second communication device 300.

However, parameters Nₑ and/or L, or parts of the mentioned parameters, could also be provided implicitly. For example, the parameters Nₑ and L could be predetermined and defined by standards for different modulation symbol constellations, for different number of allocated subcarriers, for different parameters of a frequency domain filter, etc. This avoids the use of control signaling and thus reduces the overhead in the communication system 500.

Moreover, when the first communication device 100 is a UE, the UE should signal to the BS whether it supports the use of SE. This can be done by so called UE capability signaling. In other words, the first communication device 100 may be configured to transmit a second control signal 530 indicating the capability of the first communication device 100 of repeating the Nₑ number of Fourier coefficients as shown in step III in FIG. 12. The second communication device 300 in step IV in FIG. 12 receives the second control signal 530 and thereby derives the information about the repeating capability of the first communication device 100.

Furthermore, if the FDSS window is not given by the communication standard, the first communication device 100 (e.g., a UE) could signal to the second communication device 300 (e.g., a BS) a value Nₑ^{(opt)} which is the maximum value of Nₑ beyond which PAPR reduction is not achieved. In this way, the BS can avoid determining a larger value of Nₑ than is needed.

It may be noted that the signaling of the first control signal 520 and the second control signal 530 may be performed in the reverse order, i.e., transmitting the first control signal 520 after the second control signal 530, without deviating from the scope of the disclosed solution. The first control signal 520 and the second control signal 530 may also be transmitted concurrently.

Communication resources for the UE to transmit on the uplink can either be preconfigured, e.g., by semi-persistent scheduling or configured grant. Alternatively, the BS may transmit via a physical downlink control channel (PDCCH) an uplink grant to the UE containing information about the transmission, including the allocated resources blocks for the mentioned transmission. In embodiments of the invention, the Nₑ subcarriers may be included in the allocated resource blocks for the transmission, i.e., the Nₑ number of Fourier coefficient repetitions are included in allocated resources for the transmission of the DFT-s-OFDM signal 510. In other embodiments of the invention, the Nₑ subcarriers may be added to the allocated resource blocks for the transmission, i.e., the Nₑ number of Fourier coefficient repetitions are added to the allocated resources for the transmission of the DFT-s-OFDM signal 510.

### Implementation Examples

The previously discussed and presented DFT-s-OFDM signal may typically be implemented by a cascade of DFT-precoding, a periodic SE with shift, a FDSS window, and an OFDM modulation as follows.

DFT-precoding: the constellation symbols {x[0], . . . , x[N_{data}−1]} are first DFT-precoded leading to the Fourier coefficients for k=0,1, . . . , N_{data}−1:

$$X [ k ] = \frac{1}{\sqrt{{N}_{d a t a}}} {\sum }_{m = 0}^{{N}_{data} - 1} x [ m ] {e}^{- j \frac{2 π}{{N}_{data}} k m} \qquad ( 15 )$$

The transmitter chain was illustrated in FIG. 6 where the constellation symbols {x[0], . . . , x[N_{data}−1]} are first DFT-precoded in the DFT block 120 leading to the Fourier coefficients {X[0], . . . , X[N_{data}−1]}.

Periodic SE with shift in SE block 122 and cyclical shift block 124: this frequency-domain sequence is allocated to an extended spectrum of N_{sc}=N_{data}+Nₑ subcarriers using periodic repetition as

$${X}^{( s e )} [ k ] = X [ k + L ( mod {N}_{d a t a} ) ] \qquad ( 16 )$$

for k=0,1, . . . , N_{sc}−1 and where L is an integer shift. Note that this definition of SE is directly valid also for Nₑ odd.

FDSS: before transmission by OFDM modulation, FDSS is applied to the Fourier coefficients in the FDSS block 126 as

$${X}^{′} [ k ] = W [ k ] {X}^{( s e )} [ k ] \qquad ( 17 )$$

where {W[0], . . . , W[N_{sc}−1]} is the FDSS window.

OFDM modulation: finally, the (normalized) time-discrete lowpass equivalent signal is obtained by N_{fft}-point IFFT for n=0,1, . . . , N_{fft}−1 in IFFT block 130 as:

$$s [ n ] = \frac{1}{\sqrt{{N}_{s c} {N}_{data}}} {\sum }_{k = 0}^{{N}_{s c} - 1} {X}^{′} [ k ] {e}^{j \frac{2 π}{{N}_{fft}} n k} \qquad ( 18 )$$

Se with Shift

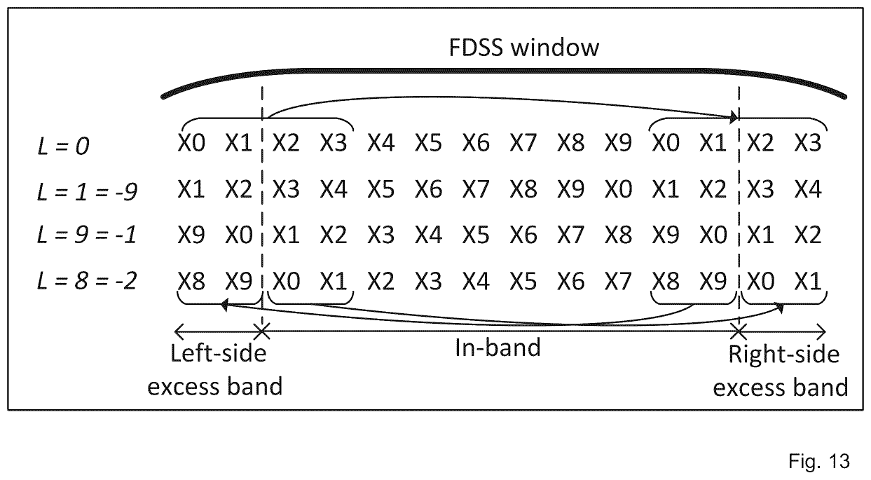

Moreover, the steps of SE with cyclical shift can be implemented via different equivalent embodiments. Different examples of the transmitted frequency-domain sequence as a function of the shift parameter L are shown in FIG. 13. For any value of L the original sequence of symbol {X[0], . . . , X[N_{data}−1]} is always included in the in-band spectrum up to a cyclic shift by

$$L - \frac{{N}_{e}}{2}$$

symbols; and the left-side excess-band symbols are always the repetition of symbols of the right-side in-band edge; and similarly for the right-side excess band. Several embodiments are disclosed for implementing the SE according to Eq. (12).

In a first exemplary implementation, as shown in FIG. 6, the SE can be implemented by appending at the end of the original N_{data}-long sequence X[k] its first Nₑ symbols and then cyclically-shifting the extended N_{sc}-long sequence by L symbols.

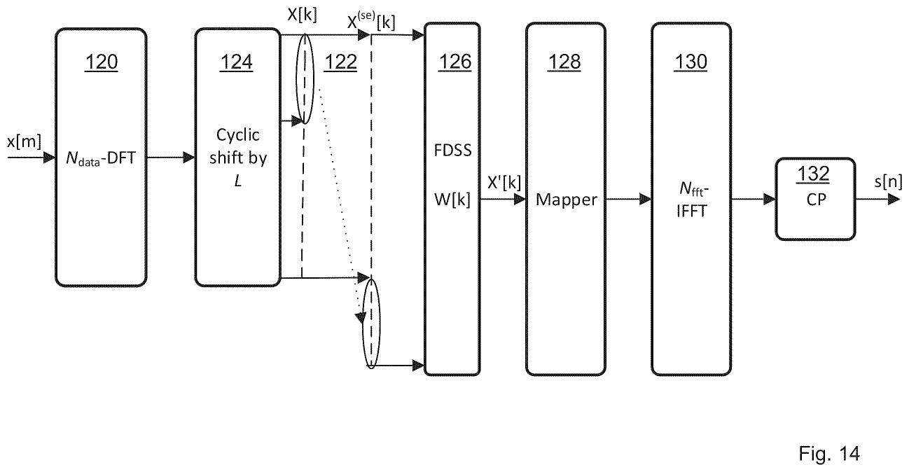

In a second exemplary implementation, as shown in FIG. 14, the cyclic SE can be implemented by first cyclically-shifting N_{data}-long sequence X[k] by L symbols and then appending after the end of this shifted sequence its first Nₑ symbols. Thus, the difference between the exemplary implementation in FIGS. 6 and 14 is the order of cyclical shifting and SE operations. In FIG. 14, the cyclical shifting is performed previous to the SE operation.

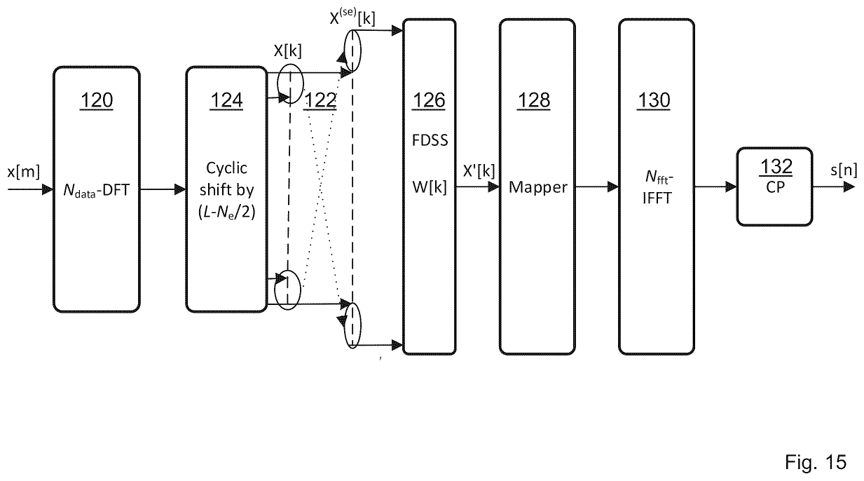

In a third exemplary implementation, as shown in FIG. 15 the SE can be implemented by first cyclically shifting the original N_{data}-long sequence X[k] by

$$( L - \frac{{N}_{e}}{2} )$$

symbols as

$$\begin{matrix}{X}^{( L )} [ k ] = X [ k + L - \frac{{N}_{e}}{2} ( mod {N}_{data} ) ] , & for k = 0 , … , {N}_{data} - 1\end{matrix} \qquad ( 19 )$$

and then appending the first and last

$$\frac{{N}_{e}}{2}$$

symbols respectively after and before this shifted sequence X^{(L)}[k], i.e.,

$${x}^{( s e )} = \{ {x}^{( L )} [ {N}_{data} - \frac{{N}_{e}}{2} ] , … , {X}^{( L )} [ {N}_{data} - 1 ] , {X}^{( L )} [ 0 ] , … , {X}^{( L )} [ {N}_{data} - 1 ] , {X}^{( L )} [ 0 ] , … , {X}^{( L )} [ \frac{{N}_{e}}{2} - 1 ] \} . \qquad ( 20 )$$

Thus, the differences between the exemplary implementation in FIGS. 6 and 15 are the order of cyclic shifting and SE operations. In FIG. 15, the cyclical shifting is performed previous to the SE operation as in FIG. 13. However, the SE is also performed in another way in FIG. 15 as in FIGS. 6 and 14. Thus, the third exemplary implementation with

$$L = {N}_{data} - \frac{{N}_{e}}{2} = - \frac{{N}_{e}}{2} ( mod {N}_{data} )$$

corresponds to the symmetrical SE of conventional solution, cf. L=−2 in FIG. 13. Note that this selection of shift parameter L depends only on Nₑ and actually is independent of N_{data} as L is computed in N_{data}-modulo arithmetic. Moreover, we remark that the selection of L is purely for convenience as it does not bring any additional benefit.

### Dmrs Transmission

In 5G NR, demodulation reference symbols (DMRS) are multiplexed together with data symbols, referred as physical uplink shared channel (PUSCH) in NR, where typically, only few OFDM symbols carries DMRS, for example 1 out of 14.

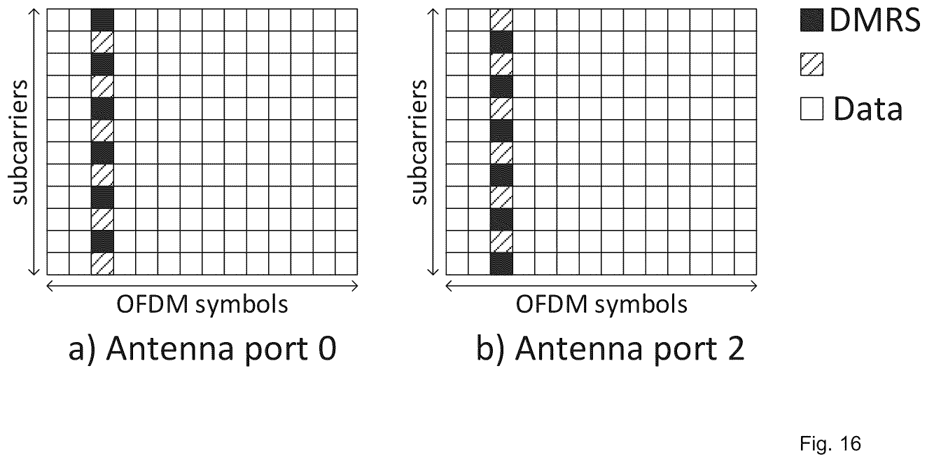

In the case that DFT-s-OFDM is used, DMRS are time-multiplexed with PUSCH. In an OFDM symbol carrying DMRS, the DMRS sequence is inserted without DFT-precoding on every other subcarrier (called resource element (RE) in NR) out of the N_{sc} subcarrier of the full transmission bandwidth, while other REs are blocked for data transmission. Two examples of possible configurations are shown in FIG. 16.

When data transmission is modulated π/2-BPSK, one type of DMRS sequence is DFT precoded pseudo-noise π/2-BPSK. Therefore, the properties of SE discussed for data transmission directly extends directly to such DMRS sequences.

For other constellations, another type of DMRS sequence is Zadoff-Chu (ZC) sequence. A DMRS sequence of length M_{ZC} have elements obtained by cyclic-extension

$$\overline{Z} [ k ] = Z [ k ( mod {N}_{ZC} ) ] , k = 0 , … , {M}_{Z C} - 1 , \qquad ( 25 )$$

of a ZC sequence

$$Z [ k ] = {e}^{\frac{j π uk ( k + 1 )}{{N}_{ZC}}} , k = 0 , … , {N}_{Z C} - 1 , \qquad ( 26 )$$

with largest prime length satisfying N_{ZC}≤M_{ZC}. The possible root indices are u=1, . . . , N_{ZC}−1.

Note that the ZC sequence is a constant amplitude zero autocorrelation sequence (CAZAC) sequence and the IDFT of a ZC sequence is also a CAZAC sequence. Because of this property one can anticipate that DMRS with ZC sequence is a type of DFT-s-OFDM transmission and therefore the properties of SE discussed for data transmission also extends directly to such DMRS sequences.

Since the FDSS window for data transmission is typically not known at the receiver, the DMRS sequence needs to be shaped by the same FDSS window as the data symbols. Three options can be considered depending on the receiver capability.

Option A: the second communication device 300 as a receiver is only capable to decode the in-band spectrum without extension, it follows that the DMRS sequence needs to be designed according to the in-band, i.e., M_{ZC}=N_{data}/2

Option B: the second communication device 300 as a receiver is able to exploit the reception of the excess band symbols, and the DMRS sequence needs to be designed according to the whole allocation bandwidth M_{ZC}=N_{sc}/2.

Option C is to accommodate the two types of receivers with the same DMRS design. The sequence is first designed according to the in-band and then spectrally-extended to the whole allocation band. The DMRS sequence design becomes

$$\overline{Z} [ k ] = Z [ L + k ( mod {N}_{ZC} ) ] , k = 0 , … , {N}_{s c} / 2 - 1 \qquad ( 23 )$$

where N_{ZC} is the largest prime length satisfying N_{ZC}≤N_{data}/2. The sequence without SE starts in the in-band, for this a symmetric extension is used which is equivalent to shift it by L=round((N_{data}−N_{sc})/4).

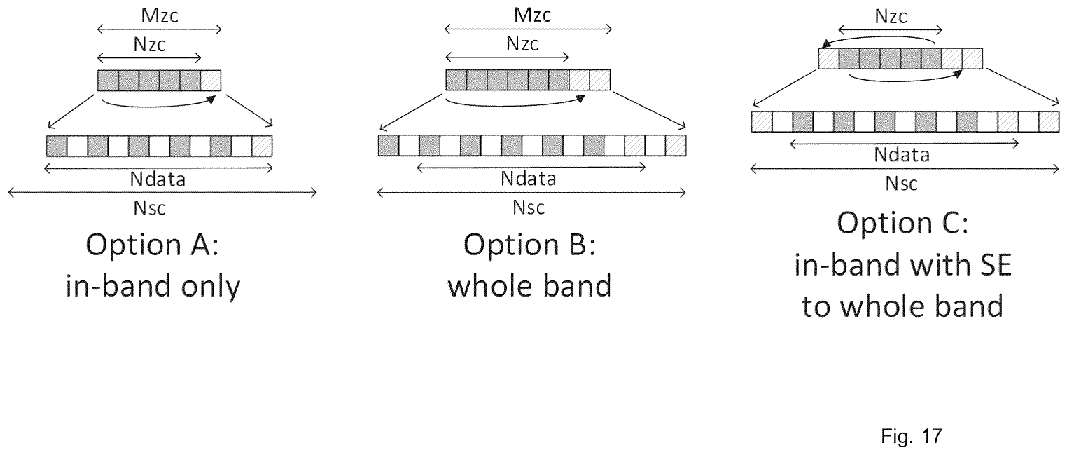

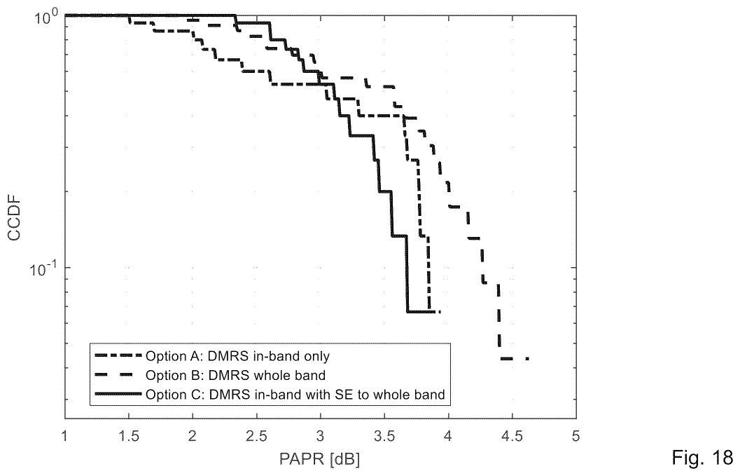

These three options of DMRS designs are illustrated in FIG. 17. Their different PAPR with an RRC window, N_{sc}=96 and N_{data}=72 is shown in FIG. 18. The choice of N_{data} in FIG. 18 corresponds to have an SE of 25% of N_{sc} which is the optimum for PAPR reduction of QPSK data transmission for this FDSS window. As it can be observed Option C has the largest PAPR but this should be balanced by the fact it generates more sequences: 31 with Option B compared to 23 with Option A and C. Otherwise, the SE DMRS design Option C decreases the PAPR of Option A.

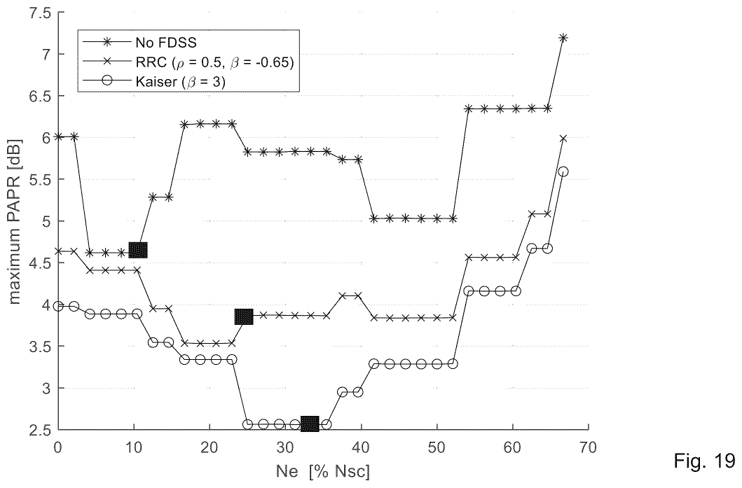

Finally, in FIG. 19 we compare the maximum PAPR of Option C with N_{sc}=96, different SE size Nₑ=(N_{sc}−N_{data}) and three different FDSS windows. Interestingly, the maximum PAPR of DMRS with SE behaves similarly than with data transmission. We can observe the PAPR first decreases to a minimum and then increase again. The SE size providing the lowest PAPR with DMRS is close the same SE size minimizing the PAPR with QPSK data transmission.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first communication device 100 and the second communication device 300 comprise the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device 100 and the second communication device 300 may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A communication device for a communication system comprising:
processing circuitry configured to:
obtain N_{data} Fourier coefficients based on N_{data} data symbols, wherein N_{data} is a positive integer;
repeat Nₑ Fourier coefficients of the N_{data} Fourier coefficients to obtain N_{sc} Fourier coefficients, wherein Nₑ and N_{sc} are positive integers and wherein Nₑ is determined based on at least one of: a modulation symbol constellation of the N_{data} data symbols, and a frequency domain spectrum shaping-(FDSS) window of the communication device;
multiply the N_{sc} Fourier coefficients with an FDSS window of size N_{sc} to obtain N_{sc} frequency shaped Fourier coefficients;
map the N_{sc} frequency shaped Fourier coefficients on N_{sc} subcarriers to obtain a discrete Fourier transform spread orthogonal frequency division multiplexing (DFT-s-OFDM) signal; and
transmit the DFT-s-OFDM signal.

2. The communication device according to claim 1, wherein Nₑ is determined further based on N_{sc} or N_{data}.

3. The communication device according to claim 1, wherein the modulation symbol constellation of the N_{data} data symbols is a π/2-BPSK constellation or a QAM constellation.

4. The communication device according to claim 1, wherein the Nₑ Fourier coefficient repetitions are:
included in allocated resources for the transmission of the DFT-s-OFDM signal; or
added to the allocated resources for the transmission of the DFT-s-OFDM signal.

5. The communication device according to claim 1, the processing circuitry being further configured to, prior to multiplying the N_{sc} Fourier coefficients with the FDSS window:
cyclically shift the N_{sc} Fourier coefficients with L Fourier coefficients to obtain N_{sc} cyclically shifted Fourier coefficients, wherein L is a positive integer;
multiply the N_{sc} cyclically shifted Fourier coefficients with the FDSS window of size N_{sc} to obtain N_{sc} frequency shaped and cyclically shifted Fourier coefficients; and
map the N_{sc} frequency shaped and cyclically shifted Fourier coefficients on the N_{sc} subcarriers to obtain the DFT-s-OFDM signal.

6. The communication device according to claim 5, wherein L is determined based on any of:
Nₑ, N_{data} or N_{sc};
the modulation symbol constellation of the N_{data} number of data symbols; and
formulas
$$L = round ( \frac{( 2 k + 1 )}{8} {N}_{data} - \frac{( {N}_{e} - 1 )}{2} ) , or L = ⌈ \frac{( 2 k + 1 )}{8} {N}_{data} - \frac{( {N}_{e} - 1 )}{2} , or L = ⌊ \frac{( 2 k + 1 )}{8} {N}_{data} - \frac{( {N}_{e} - 1 )}{2} ⌋ or L = round ( {N}_{data} - \frac{( {N}_{e} - 1 )}{2} ) , or L = ⌈ {N}_{data} - \frac{( {N}_{e} - 1 )}{2} ⌉ , or L = ⌊ {N}_{data} - \frac{( {N}_{e} - 1 )}{2} ⌋ ,$$
where k is a positive integer, where round(x) gives the closest integer to x, and where ┌x┐ and └x┘ are the ceiling and floor operators on x, respectively.

7. The communication device according to claim 1, wherein Nₑ≤Nₑ^{(opt)} is less than a maximum allowed Fourier coefficient repetition capability Nₑ^{(opt)} of the communication device, and wherein Nₑ^{(opt)} is determined based on any of: the FDSS window, L, and/or N_{sc} and N_{data}.

8. The communication device according to claim 7, the processing circuitry being further configured to:
determine Nₑ≤Nₑ^{(opt)} to minimize a peak-to-average-power ratio (PAPR) of the transmission of the DFT-s-OFDM signal based on one or more of: the FDSS window, the modulation symbol constellation of the N_{data} data symbols, L, and/or N_{sc} or N_{data}.

9. A communication device for a communication system comprising:
processing circuitry configured to:
receive a discrete Fourier transform spread orthogonal frequency division multiplexing (DFT-s-OFDM) signal from a further communication device, the DFT-s-OFDM signal comprising N_{sc} Fourier coefficients mapped on N_{sc} subcarriers, wherein N_{sc} is a positive integer;
obtain the N_{sc} Fourier coefficients based on the DFT-s-OFDM signal, the N_{sc} Fourier coefficients comprising N_{data} Fourier coefficients and Nₑ repeated Fourier coefficients of the N_{data} Fourier coefficients, wherein N_{data} and Nₑ are positive integers, and wherein the N_{data} Fourier coefficients are obtained based on N_{data} data symbols, and wherein Nₑ is determined based on at least one of a modulation symbol constellation of the N_{data} data symbols, and a frequency domain spectrum shaping (FDSS) window of a further communication device;
obtain the N_{data} Fourier coefficients based on the N_{sc} Fourier coefficients; and
decode the N_{data} Fourier coefficients to obtain the N_{data} data symbols.

10. The communication device according to claim 9, wherein Nₑ is determined further based on N_{sc} or N_{data}.

11. The communication device according to claim 9, wherein the modulation symbol constellation of the N_{data} data symbols is a π/2-BPSK constellation or a QAM constellation.

12. The communication device according to claim 9, wherein the Nₑ Fourier coefficient repetitions are:
included in allocated resources for the transmission of the DFT-s-OFDM signal; or
added to the allocated resources for the transmission of the DFT-s-OFDM signal.

13. The communication device according to claim 9, the processing circuitry being further configured to:
cyclically shift the N_{sc} Fourier coefficients with L Fourier coefficients to obtain N_{sc} cyclically shifted Fourier coefficients, wherein L is a positive integer; and
obtain the N_{data} Fourier coefficients based on the N_{sc} cyclically shifted Fourier coefficients.

14. The second communication device according to claim 13, wherein L is determined based on one or more of:
Nₑ, N_{data}, and/or N_{sc};
the modulation symbol constellation of the N_{data} data symbols; and/or
formulas
$$L = round ( \frac{( 2 k + 1 )}{8} {N}_{data} - \frac{( {N}_{e} - 1 )}{2} ) , or L = ⌈ \frac{( 2 k + 1 )}{8} {N}_{data} - \frac{( {N}_{e} - 1 )}{2} ⌉ , or L = ⌊ \frac{( 2 k + 1 )}{8} {N}_{data} - \frac{( {N}_{e} - 1 )}{2} ⌋ or L = round ( {N}_{data} - \frac{( {N}_{e} - 1 )}{2} ) , or L = ⌈ {N}_{data} - \frac{( {N}_{e} - 1 )}{2} ⌉ , or L = ⌊ {N}_{data} - \frac{( {N}_{e} - 1 )}{2} ⌋ ,$$
where k is a positive integer k, where round(x) gives the closest integer to x, and where ┌x┐ and └x┘ are the ceiling and floor operators on x, respectively.

15. The second communication device according to claim 9, wherein Nₑ≤Nₑ^{(opt)}, wherein Nₑ^{(opt)} is a maximum allowed Fourier coefficient repetition capability of -the first communication device, and wherein Nₑ^{(opt)} is determined based on one or more of: the FDSS window, L, and/or N_{sc} and N_{data}.

16. The second communication device according to claim 15, wherein Nₑ≤Nₑ^{(opt)} to minimize a peak-to-average-power ratio (PAPR) of the transmission of the DFT-s-OFDM signal based on one or more of: the FDSS window, the modulation symbol constellation of the N_{data} number of data symbols, L, and/or N_{sc} or N_{data}.

17. A method for a communication device, the method comprising:
obtaining N_{data} Fourier coefficients based on N_{data} data symbols, wherein N_{data} is a positive integer;
repeating Nₑ Fourier coefficients of the N_{data} Fourier coefficients to obtain N_{sc} Fourier coefficients, wherein Nₑ and N_{sc} are positive integers and wherein Nₑ is determined based on at least one of: _a modulation symbol constellation of the N_{data} data symbols and/or a frequency domain spectrum shaping (FDSS) window of the first communication device;
multiplying the N_{sc} Fourier coefficients with the FDSS window of size N_{sc} to obtain N_{sc} frequency shaped Fourier coefficients;
mapping the N_{sc} frequency shaped Fourier coefficients on N_{sc} subcarriers to obtain a discrete Fourier transform spread orthogonal frequency division multiplexing (DFT-s-OFDM) signal; and
transmitting the DFT-s-OFDM signal.

18. The method according to claim 16, wherein Nₑ is determined further based on N_{sc} or N_{data}.

19. A method for a communication device, the method comprising:
receiving a discrete Fourier transform spread orthogonal frequency division multiplexing (DFT-s-OFDM) signal from a first communication device, the DFT-s-OFDM signal comprising N_{sc} Fourier coefficients mapped on N_{sc} subcarriers, wherein N_{sc} is a positive integer;
obtaining the N_{sc} Fourier coefficients based on the DFT-s-OFDM signal, the N_{sc} Fourier coefficients comprising N_{data} Fourier coefficients and Nₑ repeated Fourier coefficients of the N_{data} Fourier coefficients, wherein N_{data} and Nₑ are positive integers, and the N_{data} Fourier coefficients are obtained based on N_{data} data symbols, and wherein Nₑ is determined based on at least one of a modulation symbol constellation of the N_{data} data symbols, and a frequency domain spectrum shaping (FDSS) window of the first communication device;
obtaining the N_{data} Fourier coefficients based on the N_{c}Fourier coefficients; and
decoding the N_{data} Fourier coefficients to obtain the N_{data} data symbols.

20. The method according to claim 19, wherein Nₑ is determined further based on N_{sc} or N_{data}.
